(19) United States
(12) Patent Application Publication
(10) Pub. No.: US 2013/0245841 A1
(43) Pub. Date: Sep. 19, 2013

(54) METHOD FOR CONTROLLING COMPONENT FOR NETWORK SYSTEM

(71) Applicants: Junho Ahn, Changwon-si (KR); Yanghwan Kim, Changwon-si (KR); Hoonbong Lee, Changwon-si (KR); Koonseok Lee, Changwon-si (KR); Minchel Kim, Changwon-si (KR); Jinseung Park, Changwon-si (KR); Pyeongwon Park, Changwon-si (KR); Yonghwan Bae, Changwon-si (KR); Jinhwan Son, Changwon-si (KR); Wonkyo Jung, Changwon-si (KR)

(72) Inventors: Junho Ahn, Changwon-si (KR); Yanghwan Kim, Changwon-si (KR); Hoonbong Lee, Changwon-si (KR); Koonseok Lee, Changwon-si (KR); Minchel Kim, Changwon-si (KR); Jinseung Park, Changwon-si (KR); Pyeongwon Park, Changwon-si (KR); Yonghwan Bae, Changwon-si (KR); Jinhwan Son, Changwon-si (KR); Wonkyo Jung, Changwon-si (KR)

(21) Appl. No.: 13/806,660

(22) PCT Filed: Jun. 27, 2011
(86) PCT No.: PCT/KR11/04652

§ 371 Date: May 7, 2013

(30) Foreign Application Priority Data
Jun. 26, 2010 (KR) 10-2010-0060883
Jun. 26, 2010 (KR) 10-2010-0060888
Jun. 26, 2010 (KR) 10-2010-0060894

(51) Int. Cl. G06F 1/26

(52) U.S. Cl. CPC G06F 1/26
USPC 700/286

(57) ABSTRACT

Provided is a method of controlling a component for a network system. The method of controlling a component for a network system includes recognizing energy information or additional information except the energy information, determining a driving method of the component on the basis of former driving information of the component according to the recognized information, and driving the component through the determined driving method.

### BACKGROUND

The present disclosure relates to a method of controlling a component for a network system.

Providers simply provide energy sources such as electricity, water, and gas, and consumers simply use the supplied energy sources. This makes it difficult to effectively manage the production, distribution and use of energy. Therefore, a network system for effectively managing energy is in need.

### SUMMARY

Embodiments provide a method of controlling a component for a network system which can effectively manage an energy source.

In one embodiment, a method of controlling a component for a network system includes: recognizing energy information or additional information except the energy information; determining a driving method of the component on the basis of former driving information of the component according to the recognized information; and driving the component through the determined driving method.

When the recognized information is high-price period information, the driving method of the component may be determined on the basis of the former driving information of the component.

The driving method of the component may be determined so that an energy usage amount or energy usage charge of the component is equal to or less than former energy usage amount or energy usage charge of the component.

The former driving information of the component may be information related to energy usage information or energy usage charge of the component.

The former driving information of the component may be information related to a mean energy usage amount or mean energy usage charge of the component when the component is driven one time.

The former driving information of the component may be an average of a target value set for a specific time.

The former driving information of the component may be information related to a resource received in the component when the component is driven for a specific time.

The information related to the resource may be information related to a mean discharge amount of the resource for the specific time. The resource may include water or ices.

The former driving information of the component may include driving modes or driving times of the component. When a priority order of the plurality of driving modes is defined, and the recognized information is high-price information, and the component may be driven according to the driving mode having a first priority order.

The method may further include selecting a driving mode of the component, wherein, when the recognized information is low-price period information, the driving method of the component may be determined on the basis of the selected driving mode.

The determining of the driving method may be performed while the component is driven, and the current driving method of the component may be changeable into a different method.

When the recognized information is high-price period information, an output of the component when the component is driven through the changed driving method may be reduced than that of the component when the component is driven the driving method before being changed.

The output of the component may be reduced in stages in a portion or the whole of a high-price period.

The output of the component may be continuously reduced in a portion or the whole of a high-price period.

The details of one or more embodiments are set forth in the accompanying drawings and the description below. Other features will be apparent from the description and drawings, and from the claims.

### BRIEF DESCRIPTION OF THE DRAWINGS

FIG. 1 is a view schematically showing an example of a network system according to the present disclosure.

FIG. 2 is a block diagram schematically showing an example of the network system according to the present disclosure.

FIG. 3 is a block diagram showing an information transmission process on the network system according to the present disclosure.

FIG. 4 is a view showing the communication structure of two components that constitute the network system according to a first embodiment.

FIG. 5 is a block diagram showing the detailed configuration of a communication device that constitutes a communication unit.

FIG. 6 is a view showing a communication performing process between a specific component and a communication device according to the first embodiment.

FIG. 7 is a view showing a communication performing process between a specific component and a communication device according to a second embodiment.

FIG. 8 is a view showing the communication structure of components that constitute the network system according to a third embodiment.

FIG. 9 is a block diagram showing the detailed configuration of a first component in FIG. 8.

FIG. 10 is a view showing the communication structure of components that constitute the network system according to a fourth embodiment.

FIG. 11 is a block diagram showing the detailed configuration of a first component in FIG. 10.

FIG. 12 is a schematic view of a home area network according to an embodiment.

FIG. 13 is a block diagram of an energy consumption component constituting the home area network according to an embodiment.

FIG. 14 is a flowchart illustrating an order of controlling a network system according to a first embodiment.

FIG. 15 is a flowchart illustrating a method of controlling the network system according to the first embodiment.

FIG. 16 is a perspective view of a washing machine which is an example of the energy consumption component constituting the home area network according to an embodiment.

FIG. 17 is a flowchart for explaining a method of controlling the washing machine of FIG. 16.

FIG. 18 is a flowchart for explaining a method of controlling a washing machine according to a second embodiment.

FIG. 19 is a block diagram of a water purifier which is an example of the energy consumption component constituting the home area network according to an embodiment.

FIG. 20 is a flowchart for explaining a method of controlling the water purifier of FIG. 19.

FIG. 21 is a block diagram of a refrigerator which is an example of the energy consumption component constituting the home area network according to an embodiment.

FIG. 22 is a flowchart for explaining a method of controlling the refrigerator of FIG. 21.

FIG. 23 is a graph illustrating an output variation of one component in high-price and low-price periods according to the first embodiment.

FIG. 24 is a graph illustrating an output variation of one component in high-price and low-price periods according to the second embodiment.

### DETAILED DESCRIPTION OF THE EMBODIMENTS

Reference will now be made in detail to the embodiments of the present disclosure, examples of which are illustrated in the accompanying drawings.

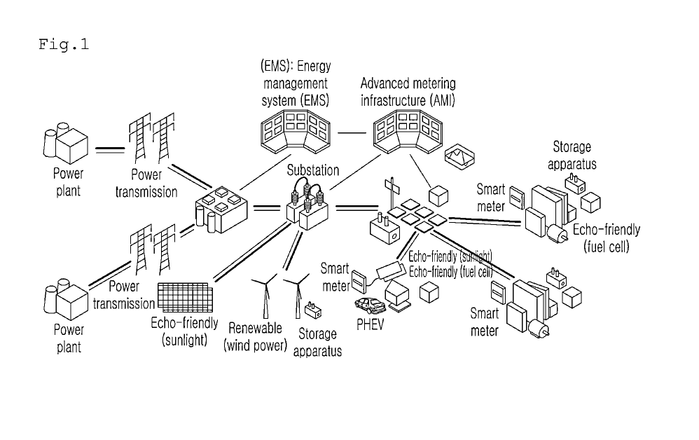

FIG. 1 is a view schematically showing an example of a network system according to the present disclosure.

The network system is a system for managing an energy source such as electricity, water or gas. The energy source means one of which amount generated or used can be metered. Therefore, even a source not mentioned above may be used as the energy source. Hereinafter, electricity will be described as an example of the energy source, and details of this specification may be identically applied to other energy sources.

Referring to FIG. 1, a network system according to an embodiment includes a power plant for producing electricity. The power plant may include a power plant for producing electricity through a thermal power generation or nuclear power generation and a power plant using water power, sunlight power, wind power or the like which is eco-friendly energy.

The electricity produced in the power plant is transmitted to a sub-control center through a power transmission line, and the sub-control center transmits the electricity to a substation so that the electricity is distributed to customers such as houses or offices.

Electricity produced by the eco-friendly energy is also transmitted to the substation so as to be distributed to each of the customers. The electricity transmitted from the substation is distributed to each of the offices or houses through electricity power storage, or is directly distributed to each of the offices or houses.

In a house using a home area network (HAN), electricity may be produced by itself through sunlight, fuel cells built in a plug-in hybrid electric vehicle (PHEV), or the like. Also, the produced electricity may be stored or distributed, or surplus electricity may be resold to the outside world.

The network system may include a smart meter for detecting the amount of electricity used in each customer (house, office or the like) in real time, and an advanced metering infrastructure (AMI) for metering the amount of electricity used in a plurality of customers.

The network system may further include an energy management system (EMS) for managing energy. The EMS may generate information on operations of one or more components with respect to energy (production of energy, distribution of energy, usage of energy, storage of energy, and the like). The EMS may generate at least a command for the operations of the components.

In this specification, a function or solution performed by the EMS may be referred to as an energy management function or energy management solution.

In the network system, one or more EMSs may be provided as a separate configuration, or the EMS may be included as an energy management function or energy management solution in one or more components.

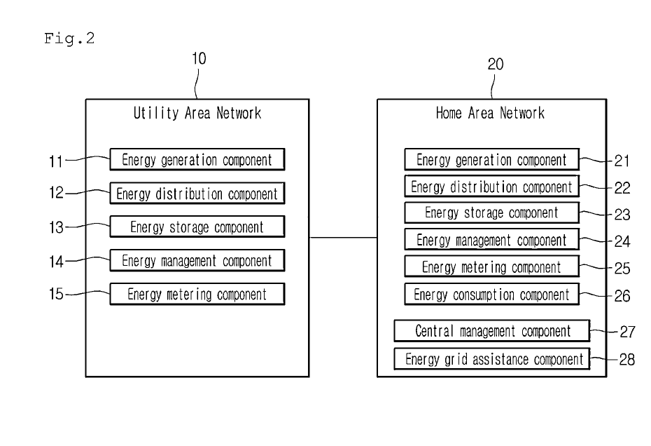

FIG. 2 is a block diagram schematically showing an example of the network system according to the present disclosure.

Referring to FIGS. 1 and 2, the network system according to the present disclosure is configured by a plurality of components. For example, the components of the network system are a power plant, a substation, a sub-control center, an EMS, electric home appliances, a smart meter, a storage battery, a web server, an AMI, a home server, and the like.

In the present disclosure, each of the components may be configured by a plurality of sub-components. As an example, in a case of one component is an electric home appliance, sub-components may be a microcomputer (MICOM), a heater, a display and the like. That is, all that perform a specific function may be components in the present disclosure, and such components constitute the network system of the present disclosure. Two components may communicate with each other by means of a communication unit. One network may be one component or may be configured by a plurality of components.

In this specification, the network system in which communication information is related to an energy source may be referred to as an energy grid.

A network system according to an embodiment may include a utility area network (UAN) 10 and a home area network (HAN) 20. The UAN 10 and the HAN 20 may perform wired or wireless communication by means of a communication unit, and may perform two-way communication.

In this specification, the term “home” means not only a household as a lexical meaning but also a group in which specific components such as buildings or companies gather. Also, the term “utility” means a group in which specific components outside the home gather.

The UAN 10 includes an energy generation component 11 for generating energy, an energy distribution component 12 for distributing or transmitting energy, an energy storage component 13 for storing energy, an energy management component 14 for managing energy, and an energy metering component 15 for metering information related to energy.

In a case where one or more components that constitute the UAN 10 consume energy, the components that consume the energy may be energy consumption components.

The energy consumption component is a component corresponding to the energy consumption component 26 that constitutes the HAN 20. The energy consumption component may be the same component as the energy consumption component 26 or may be another component distinguished from the energy consumption component 26.

The energy generation component 11 may be a power plant as an example. The energy distribution component 12 distributes or transmits energy generated in the energy generation component 11 and/or energy stored in the energy storage component 13 to the energy consumption component 26 that consumes the energy. The energy distribution component 12 may be a power transmitter, substation, sub-control center, or the like.

The energy storage component 13 may be a storage battery, and the energy management component 14 generates information for driving one or more of the energy generation component 11, the energy distribution component 12, the energy storage component 13 and the energy consumption component 26, related to energy. The energy management component 14 may generate at least a command for the operation of a specific component.

The energy management component 14 may be an EMS. The energy metering component 15 may meter information related to the generation of energy, the distribution of energy, the usage of energy, the storage of energy, and the like. The energy metering component 15 may be an AMI as an example. The energy management component 14 may be a separate configuration, or may be included in another component as an energy management function.

The UAN 10 may communicate with the HAN 20 by a terminal component (not shown). That is, information generated or transferred in a specific component that constitutes the UAN may be transmitted to the HAN 20 through the terminal component, or information generated or transferred in another component that constitutes the HAN 20 may be received to the UAN 10 through the terminal component. The terminal component may be a gate way as an example. The terminal component may be provided to one or more of the UAN 10 and the HAN 20.

The terminal component may be a component necessary for transmitting/receiving information between the UAN and the HAN.

Two components that constitute the UAN 10 may communicate with each other by means of a communication unit.

The HAN 20 includes an energy generation component 21 for generating energy, an energy distribution component 22 for distributing energy, an energy storage component 23 for storing energy, an energy management component 24 for managing energy, an energy metering component 25 for metering information related to energy, an energy consumption component 26 for consuming energy, a central management component 27 for controlling a plurality of components, and an energy grid assistance component 28.

The energy generation component 21 may be a home power generator, and the energy storage component 23 may be a storage battery. The energy management component 24 may be an EMS. As an example, the energy generation component 21 may be a solar cell, a fuel cell, a wind power generator, a power generator using subterranean heat, a power generator usng seawater, or the like.

The energy storage component 23 may perform storage using energy generated from the energy generation component 21. Therefore, in view of the use of energy, the energy storage component 23 and the energy generation component 11 may be an energy using component that uses energy together with the energy consumption component 26. That is, the energy using component may include at least an energy consumption component, an energy generation component and an energy storage component. In a case where the energy management component uses energy, it may be included in the energy using component.

In view of the supplied energy, the energy storage component 23, the energy consumption component and the energy generation component 11 may be an energy supplied component to which energy is supplied.

The energy metering component 25 may meter information related to the generation of energy, the distribution of energy, the usage of energy, the storage of energy, and the like. The energy metering component 25 may be a smart meter as an example. The energy consumption component may be, as an example, an electric home appliance or a heater, motor, display or the like, which constitutes the electric home appliance. In this embodiment, there is no limitation in the kind of the energy consumption component 26.

Although not shown, the network system may include an accessory component or a consumable handling component. The accessory component may be an energy network-only component which performs an additional function for the energy network. For example, the accessory component may be an energy network-only weather reception antenna.

The consumable handling component may be a component for storing, supplying, and transferring a consumable and confirms and recognize information about the consumable. For example, the consumable may be a product or material which is used or handled during the operation of the component. Also, the consumable handling component may be managed in the energy network, e.g., the energy management component. For example, the consumable may be a washing cloth of a washing machine, a cooked item of a cooking apparatus, or a detergent for cleaning the washing cloth in the washing machine, or a fiber conditioner, or seasoning for cooking item.

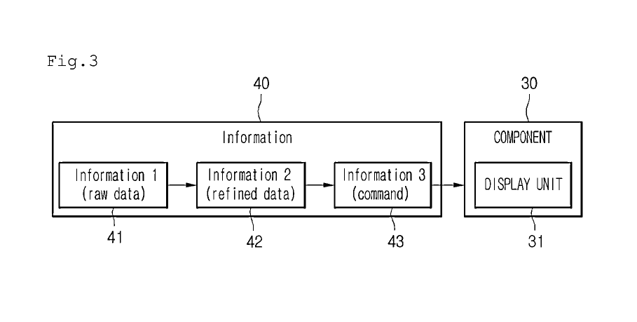

FIG. 3 is a block diagram showing an information transmission process on the network system according to the present disclosure.

Referring to FIG. 3, in the network system according to the present disclosure, a specific component 30 may receive information related to energy (hereinafter, referred to as energy information 40) by means of a communication unit. The specific component 30 may further receive additional information (environment information, time information and the like) by means of the communication unit. In this instance, the information may be received from another component. That is, at least energy information is contained in the received information.

The specific component 30 may be a component that constitutes the UAN 10 or a component that constitutes the HAN 20.

As described above, the energy information 40 may be one of information related to electricity, water, gas and the like. Hereinafter, information related to electricity will be described as an example of the energy information, but information related to other energy sources may be identically applied.

For example, the kind of information related to the electricity may include time-based pricing, curtailment, grid emergency, grid reliability, energy increment, operation priority, and the like.

The information may be divided into scheduled information previously produced based on previous information, and real-time information changed in real time. The scheduled information and the real-time information may be divided by whether or not predict information after the current time (in the future).

The energy information 40 may be transmitted/received as a true or false signal such as a Boolean signal on the network system, or may be transmitted/received as a real price. Alternatively, the energy information 40 may be transmitted/received by being divided into a plurality of levels.

The energy information 40 may be divided into time of use (TOU) information, critical peak pattern (CPP) information or real time pattern (RTP) information according to the change in the pattern of data with respect to time.

According to the TOU information, a data is changed step by step depending on time. According to the CPP information, a data is changed step by step or in real time depending on time, and emphasis is displayed at a specific point of time. According to RTP information, a data is changed in real time depending on time.

In a case where the energy information is time-based pricing information as an example, the time-based pricing information is changed. The time-based pricing information may be transmitted/received as a true or false signal such as a Boolean signal on the network system, or may be transmitted/received as a real price. Alternatively, the time-based pricing information may be transmitted/received by being divided into a plurality of levels.

In a case where the specific component 30 receives a true or false signal such as a Boolean signal, one signal may be recognized as an on-peak signal, and the other signal may be recognized as an off-peak signal.

Alternatively, the specific component 30 may recognize information on at least one drive, which contains the time-based information, and may recognize an on-peak or off-peak signal by comparing the value of the recognized information with the value of reference information.

For example, in a case where the specific component 30 recognizes information divided into levels or real pricing information, it recognizes an on-peak or off-peak signals by comparing the value of the recognized information with the value of reference information.

In this case, the value of the information on drive may be at least one of time-based pricing, electric energy, the variation of time-based pricing, the variation of electric energy, the average of time-based pricing and the average of electric energy. The value of reference information may be at least one of an average, the average between maximum and minimum values of power information during a predetermined period of time and the reference variation of power information during the predetermined period of time (e.g., the slope of consumed electric energy per unit time).

The value of reference information may be determined in real time or may be previously determined. The value of reference information may be determined on the UAN or may be determined on the HAN (a customer's direct input or an input from the energy management component, the central management component or the like).

In a case where the specific component 30 (e.g., the energy consumption component) recognizes an on-peak signal (e.g., at a point of time of recognition), an output may be determined as zero (stop or maintenance of a stop state) or may be decreased. If necessary, the output may be restored or increased. The driving scheme of the specific component may be previously determined before the specific component is operated, or may be changed when the specific component recognizes an on-peak signal posterior to the start of operation.

Alternatively, in a case where the specific component 30 recognizes an on-peak signal (e.g., at a point of time of recognition), the output is maintained under an operable condition. In this case, the operable condition means that the value of the information on drive is less than a predetermined reference. The value of the information on drive may be time-based pricing, consumed electric energy, operation time, or the like. The predetermined reference may be a relative or absolute value.

The predetermined reference may be determined in real time or may be previously determined. The predetermined reference may be determined on the UAN or may be determined on the HAN (a customer's direct input or an input from the energy management component, the central management component or the like).

Alternatively, in a case where the specific component 30 recognizes high-cost information, the output of the specific compoinent may be maintained or increased when the difference between a state information value and a reference value is within a predetermined range. For example, in a case where a compressor of a refrigerator is not operated in a low-cost section, the temperature of a cool chamber or freezing chamber is increased. Therefore, the compressor is necessarily turned on when the temperature of the cool chamber or freezing chamber approaches a reference temperature. In a case where a high-cost section comes after the compressor is turned on, the compressor maintains a current output when the difference between the temperature of the cool chamber or freezing chamber and the reference temperature is within a predetermined range. In a case where a user selects a button for cancelling power saving in the state that the specific component 30 recognizes the high-cost information, the output of the specific component may be maintained.

Alternatively, in a case where the specific component 30 recognizes an on-peak signal (e.g., at a point of time of recognition), the output may be increased. However, although the output is increased at the point of time when the specific component recognizes the on-peak signal, the total output amount of the specific component during the entire drive period may be decreased or maintained as compared with that when the specific component is operated at a normal output level. Alternatively, although the output is increased at the point of time when the specific component recognizes the on-peak signal, the total consumed power or total time-based pricing of the specific component during the entire operation period may be decreased as compared that when the specific component is operated at a normal output level.

In a case where the specific component 30 recognizes an off-peak signal (e.g., at a point of time of recognition), the output may be increased. For example, in a case where the operation reservation of the specific component is set up, the drive of the specific component may be started before the setup time, or a component having a large output among a plurality of components may be first driven. In a case where the specific component is a refrigerator, supercooling may be performed by increasing an output as compared with the existing output (change in the state of cool air that is a medium for performing the function of the refrigerator). In a case where the specific component is a washing machine or washer, hot water may be stored by driving a heater earlier than the time when the heater is to be operated (storage of hot water that is an additional medium for performing the function of the washing machine or washer). Alternatively, in a case where the specific component is a refrigerator, cool air may be stored in a separate supercooling chamber by increasing an output as compared with the existing output. Alternatively, in a case where the specific component recognizes an off-peak signal (e.g., at a point of time of recognition), electricity may be stored.

The curtailment information is information related to a mode in which the specific component is stopped or a small amount of time-based pricing is taken. As an example, the curtailment information may be transmitted/received as a true or false signal such as a Boolean signal on the network system.

If the specific component 30 recognizes curtailment information, the output may be determined as zero (stop or maintenance of a stop state) or may be decreased as described above.

The grid emergency information is information related to a power failure or the like. As an example, the grid emergency information may be transmitted/received as a true or false signal such as a Boolean signal on the network system. The information related to a power failure or the like has a relation with the reliability of a component using energy.

In a case where the specific component 30 recognizes grid emergency information, it may be immediately shut down.

The grid reliability information is information related to the supply amount of electricity supplied or information related to the quality of electricity. The grid reliability information may be transmitted/received as a true or false signal such as a Boolean signal on the network system, or may be determined by a component (e.g., an electric home appliance) through the frequency of AC power supplied to the component.

That is, if a frequency lower than the frequency of AC power supplied to the component is sensed, it may be determined that the amount of electricity supplied is small (information on the deficiency of the amount of electricity supplied). If a frequency higher than the frequency of AC power supplied to the component is sensed, it may be determined that the amount of electricity supplied is large (information on the excess of the amount of electricity supplied).

In a case where the specific component recognizes shortage of the amount of electricity or poor quality of electricity in the grid reliability information, an output may be determined as zero (stop or maintenance of a stop state) or may be decreased. If necessary, the output may be restored or increased.

On the other hand, in a case where the specific component recognizes the information on the excess of the amount of electricity supplied, the output may be increased, or the operation may be converted from an off-state to an on-state.

The energy increment information is information related to a state that surplus electricity is generated because the amount of electricity used by a component is less than that of power generation. As an example, the energy increment information may be transmitted/received as a true or false signal such as a Boolean signal on the network system.

In a case where the specific component 30 recognizes energy increment information, the output may be increased. For example, in a case where the operation reservation of the specific component is set up, the drive of the specific component may be started before the setup time, or a component having a large output among a plurality of components may be first driven. In a case where the specific component is a refrigerator, supercooling may be performed by increasing an output as compared with the existing output. In a case where the specific component is a washing machine or a washer, hot water may be stored by driving a heater earlier than the time when the heater is to be operated. Alternatively, in a case where the specific component recognizes an off-peak signal (e.g., at a point of time of recognition), electricity may be stored.

Meanwhile, in a case where the specific component 30 is the energy storage component 13 or 23, the energy storage component 13 or 23 may store electricity by receiving the electricity supplied from the UAN, for example, when electricity storage cost is smaller than a predetermined value.

However, in a case where the energy storage component 23 is connected to the energy generation component 21 that constitutes the HAN, it may continuously store energy generated by the energy generation component 21 until the electricity storage is completed. That is, the energy generated while the energy generation component 21 generates energy may be stored in the energy storage component 23.

The presence of completion of the electricity storage is determined while the energy storage component 13 or 23 stores electricity. In a case where the electricity storage is completed, the electricity supply for the electricity storage is cut off. Specifically, the presence of completion of the electricity storage may be determined using a sensor that senses the voltage, temperature or current of the energy storage component 13 or 23. The cutoff of the electricity supply may be performed using a switch (or circuit breaker) provided to a supply stage through which the electricity is supplied to the energy storage unit 13 or 23.

The electricity storage cost may be cost consumed in the electricity storage for a specific time period or electricity cost at a specific time.

As an example, in a case where the electricity storage cost is in an off-peak section (in a case where the specific component recognizes low-cost information which will be described later), the energy storage component 13 or 23 may store electricity. Alternatively, in a case where an on-peak section corresponds to an allowance section (in a case where the specific component recognizes high-cost information which will be described later), the energy storage component 13 or 23 may store in the on-peak section. In this instance, the allowance section is a section in which a power consumption information value is less than a predetermined reference. The power consumption information value may be a electricity cost, a power consumption amount, a time range, or the like. The predetermined reference may be a predetermined cost, a predetermined power consumption amount, a predetermined time, or the like. The predetermined reference may be a relative value or absolute value, and may be changed automatically or manually.

The energy storage component 13 or 23 may store a counter electromotive force generated when an energy consumption component that is rotatably operated or a motor provided to the energy consumption component is stopped (rotated).

Alternatively, the energy storage component 13 or 23 may store electricity using an energy consumption component that is rotatably operated or a motor provided to the energy consumption component. For example, in a case where the energy consumption component is a refrigerator, the energy storage component 13 or 23 may store electricity generated when a fan motor provided to the refrigerator is rotated (the fan motor may serve as a power generator or may be connected to the power generator). Alternatively, in a case where the energy consumption component is a washing machine, the energy storage component 13 or 23 may store electricity generated when a motor that rotates a drum for accommodating the laundry is rotated. In a case where the energy consumption component is a cooking appliance, the energy storage component 13 or 23 may store electricity generated when a motor for rotating a cooling fan is rotated. In a case where the energy consumption component is an air cleaner, the energy storage component 13 or 23 may store electricity generated when a motor for rotating a fan is rotated. That is, in this embodiment, in a case where a motor is provided regardless of the kind of the energy consumption component, the energy storage component 13 or 23 may store electricity generated when the motor is rotated. Alternatively, in a case where a power generator is connected to a fan rotated by the flow of air (natural flow or forcible flow), the energy storage component 13 or 23 may store electricity generaged by the power generator.

The electricity stored in the energy component 13 or 23 may be supplied to one or more energy consumption components 26. In a case where electricity cost is higher than a reference value, the electricity stored in the energy component 13 or 23 may be supplied to the energy consumption component 26. As an example, in a case where the electricity cost is an on-peak (in a case where the specific component recognizes the high-cost information), the electricity stored in the energy storage component 13 or 23 may be supplied to the energy consumption component 26. In a case where the electricity cost is an off-peak (in a case where the specific component recognizes the low-cost information) but is close to the on-peak, the electricity stored in the energy storage component 13 or 21 may be supplied to the energy consumption component. If the electricity stored in the energy storage component 13 or 23 is less than a predetermined value, electricity generated in the energy generation component 11 is supplied to the energy consumption component. Thus, it is possible to prevent the operation of the energy consumption component from being stopped due to the cutoff of the electricity supply while the energy consumption component is operated.

In a case where the supply of electricity generated in the energy generation component 11 is cut off by interruption of electric power, the electricity stored in the energy component 13 or 23 may be supplied to the energy consumption component. In a case where the energy consumption component is an electric product, the electricity stored in the energy storage component 13 or 23 may be supplied to a communication unit or control unit provided to the electric product.

The electricity stored in the energy component 13 or may be supplied to a portion of a plurality of energy consumption components. As an example, the stored electricity may be supplied to an electric product such as a refrigerator required in continuous operation among a plurality of electric products. Alternatively, the stored electricity may be supplied to an energy consumption component with relatively low power among a plurality of energy consumption components that constitute one electric product. It will be apparent that the stored electricity is supplied to an energy consumption component with high power. Alternatively, when a course using a relatively small amount of power is performed among a plurality of courses in which an electric product is performed, the stored electricity may be supplied. It will be apparent that the stored electricity may be supplied even when a course using a large amount of power is performed.

Meanwhile, in a case where electricity is generated and stored by a fan or motor as described above, the electricity stored in the energy storage component 13 or 23 may be supplied to an energy consumption unit with relatively low power. As an example, the electricity stored in the energy storage component 13 or 23 may be supplied to an LED lamp, a display, a control unit, a communication unit, a low-power heater, or the like. Alternatively, in a case where the energy consumption component performs a plurality of courses, the electricity stored in the energy storage component 13 or 23 may be supplied to the energy consumption component in a course that requires low power.

The energy storage component 23 may be built in connected to one energy consumption component. Alternatively, a plurality of energy storage components 23 may be built in or connected to a plurality of energy consumption components, respectively. Alternatively, a plurality of energy storage components 23 may be built in or connected to one energy consumption component. The plurality of energy storage components 23 may be connected to one another to share the stored electricity.

Among the information related to energy, the on-peak information, the curtailment information and information on the deficiency of the amount of electricity supplied may be recognized as high-cost information considered that energy cost is relatively expensive. In this instance, the section in which the high-cost information is recognized by the specific component may referred to as a low-cost section.

On the other hand, among the information related to energy, the off-peak information, the energy increment information and the information on the excess of the amount of electricity supplied may be recognized as low-cost information considered that energy cost is relatively cheap. In this instance, the section in which the low-cost information is recognized by the specific component may be referred to as a low-cost section.

The information related to the fluctuation of the energy cost (high-cost or low-cost information) may be recognized as information for determining a power saving driving scheme of the specific component (e.g., the energy consumption component). That is, the information related to the fluctuation of the energy cost may be recognized by dividing a time slot (time period) based on energy cost or pricing period (pricing zone) for determining a driving scheme of the specific component into at least two or more.

A high period means a high price time period (period of high cost) or a high pricing period and a low period means a low price time period (period of low cost) and a low pricing period.

As an example, in a case where the information related to energy is recognized as a Boolean signal, the time slot (time period) based on energy cost or pricing period (pricing zone) for determining a driving scheme of the specific component may be divided into two. In a case where the information related to energy is divided into a plurality of levels or recognized as real-time information, the time period or pricing period may be divided into three or more.

Meanwhile, the information related to energy cost corresponding to at least time may be recognized as information for determining a power saving driving scheme of the specific component. That is, the information related to energy cost may be recognized by dividing a time slot (time period) or pricing zone (time period) into at least two or more. As described above, the divided time period or pricing period may be determined based on the kinds of the recognized information (the Bloolean signal, the plurality of levels and the real-time information).

In other words, the information related to fluctuation of energy cost may be recognized by dividing a determination factor for driving the specific component into two or more, and functions on time and energy cost may be included in the determination factor.

In a case where the information related to energy cost is divided into two levels or more, the driving scheme of the specific component may be determined according to the information divided into levels.

On the other hand, in a case where the recognized information related to energy cost is not divided based on a specific reference (e.g., real-time cost information), it is compared with predetermined information, and the driving scheme of the specific component may be determined based on the compared result.

Here, the predetermined information may be reference information (e.g. reference value) for dividing the information related to energy cost, and the compared result may be whether not the information related to energy cost is more or less than the reference value.

Specifically, each of the kinds of information related to energy may be divided into first information 41 that is raw information, second information 42 that is refined information, and third information 43 that is information for performing the function of the specific component. That is, the first information is a raw data, the second information is a refined data, and the third information is a command for performing the function of the specific component.

The information related to energy is included a signal, and the signal is transmitted. In this instance, one or more of the first to third information may be transmitted several times while the content of the information is not converted but only the signal including the information is converted.

For example, as shown in FIG. 3, a component that receives a signal including the first information may convert only the signal and transmit a new signal including the first information to another component.

Therefore, it is described in this embodiment that the conversion of signal is a different concept from the conversion of information. In this instance, it can be readily understood that when the first information is converted into the second information, the signal including the first information is also converted into the signal including the second information.

However, the third information may be transmitted several times in the state that the content of the third information is converted or in the state that only the signal including the third information is converted while the content of the third information is identically maintained.

Specifically, in a case where the first information is raw information on time-based pricing, the second information may be refined information on the time-based pricing. The refined information on the time-based pricing is information in which the time-based pricing is divided into a plurality of levels or analysis information. The third information is a command generated based on the second information.

The specific component may generate, transmit or receive one or more of the first to third information. The first to third information are not necessarily transmitted or received in sequence. Only a plurality of pieces of third information without the first and second information may be transmitted in sequence or parallel. Alternatively, the first and third information may be transmitted or received together, the second and third information may be transmitted or received together, or the first and second information may be transmitted or received together.

As an example, in a case where the specific component receives the first information, it may transmit the second information or may transmit the second and third information.

In a case where the specific information receives only the third information, it may generate and transmit new third information.

Meanwhile, in the relation between two pieces of information, one is a message and the other is a response for the message. Thus, each of the components that constitute the network system may transmit or receive a message. In a case where each of the components receives a message, it may respond to the message. Therefore, in the case of an individual component, the transmission of a message is a relative concept with the response for the message.

The message may include a data (first or second information) and/or a command (third information).

The command (third information) may include a command for storing the data, a command for generating the data, a command for processing the data (including the generation of an additional data), a command for generating an additional command, a command for transmitting the additionally generated command, a command for transmitting a received command, and the like.

In this specification, the response for the received message means storage of the data, processing of the data (including generation of an additional data), generation of a new command, transmission of the newly generated command, simple transmission of a received command (including generation of a command for transmitting the received command to another component), operation, transmission of the stored information, transmission of an acknowledge message (acknowledge character or negative acknowledge character), or the like.

For example, in a case where the message is first information, the specific component that receives the first information may generate second information by processing the first information, or may generate the second information and new third information, as a response for the message.

The specific component that receives the message may provide a response related to energy. Here, the term “response” may be understood as a concept including an operation through which the specific component can perform a function. As an example, the HAN 20 may perform an operation related to energy by receiving a message.

The response (operation) related to energy, provided by the specific component, will be described in detail. For example, the specific component may be an energy consumption component.

The energy consumption component may be driven so that the energy cost when it is driven based on the recognition for energy information is reduced as compared with that when it is driven without the recognition for energy information.

The specific component may include a plurality of modes in which it is driven to perform its own function. The plurality of modes are a first mode and a second mode in which energy cost is relatively saved as compared with that in the first mode. The specific component may be driven in at least one of the first and second modes.

Here, the first mode may be a general mode and the second mode may be a power saving mode. Alternatively, the first and second modes may all be power saving modes.

The general mode may be understood as a mode in which the function of the specific component is performed without recognition of energy information. On the other hand, the power saving mode may be understood as a mode in which the function of the specific component is performed based on the recognition of energy information so as to save energy cost.

In a case where the first and second modes are power saving modes, the first mode may be specified as a driving scheme for saving energy cost and the second mode may be specified as a driving scheme in which the energy cost in the second mode is more saved than that in the first mode.

Meanwhile, in a case where the specific component (e.g., the energy consumption component) is driven, at least a portion is recognized in a driving scheme including at least drive time and course. In this case, an unrecognized portion may be generated so as to save energy cost, and a recognized portion may be converted into another scheme.

For example, at least a portion of the driving scheme may be recognized under the control of the energy management component, the control of the energy consumption component, or the like. In a case where a specific driving scheme is further required so as to save energy cost, an unrecognized portion of the driving scheme may be newly generated, and a recognized portion may be converted into another scheme so as to save energy.

It will be apparent that the process of generating the unrecognized portion may be omitted. In this case, the process of converting the recognized portion into another scheme. On the other hand, the process of converting the recognized portion into another scheme may be omitted. In this case, the process of newly generating the unrecognized portion may be performed.

The drive time may include a drive start time or drive end time. The course may include a drive period of the specific component and the power of the specific component.

The generated scheme or converted scheme may be a scheme recommended by the specific component so as to save energy cost. Here, the specific component may be an energy consumption component (control component) or the energy management component.

As an example, in a case where the recognized scheme is a specific drive time, the specific drive time may be converted into another time so as to save energy cost, and a specific course may be generated.

On the other hand, in a case where the recognized scheme is a specific course, the specific course may be converted into another course so as to save energy cost, and a specific time may be generated.

Under the control described above, a change in time or power may be made with respect to the output function of the specific component based on time.

The generated scheme or converted scheme may be performed within a set range. That is, in the process of recognizing at least a portion of the driving scheme, the generation or conversion of the driving scheme may be performed within a predetermined reference in which the recognized portion appears (e.g., restriction set by a user, constraint set under the control of the energy management component or energy consumption component, or the like).

Therefore, in a case where the set range is out of the predetermined reference, it is restricted to generate the unrecognized portion or to convert the recognized portion into another scheme.

Another embodiment is proposed.

Cost information may further included in the recognized driving scheme. That is, in a case where the cost information is recognized, a portion related to the drive time or course may be generated. The generated driving scheme may be recommended.

Meanwhile, a response of the specific component based on the information related to the fluctuation of the energy cost (high-cost or low-cost information), e.g., a power control for power saving driving, may be performed. An output decrease (including an output of zero) or output increase may be included in the output control.

It is as described above that the output is decreased or zero, maintained or increased based on the recognition for the information (on-peak or off-peak) related to energy cost.

If high-cost information is recognized, the output may be zero or decreased. Specifically, the output in the recognition of the high-cost information may be decreased as compared with that in the recognition of low-cost information. As described above, the decrease of the output may be previously determined before the specific component is operated, or may be changed when the high-cost information is recognized posterior to the start of the operation of the specific component.

In a case where the output of the specific component is zero or decreased, the function to be performed by the specific component may be lost as compared with a normal case. Therefore, a response for restoring the lost function may be performed.

As an example, after the output of the specific component is decreased, the specific component may be controlled so that the total operation time of the specific component is increased or so that the output is increased in at least a time period.

In other words, if specific reference information related to energy information is recognized in a period after the output of the specific component is controlled, the response for controlling the output may be released. Here, the term “period” may be divided based on a point of time when the high-cost information is recognized.

The total operation time may be understood as a time approaching a specific target in the process of performing the function of the specific component. As an example, in a case where the specific component is an electric appliance (washing machine, drying machine, cooking appliance or the like) intermittently driven (or driven in a specific course), the total operation time may be understood as a time until a corresponding course is completed.

On the other hand, in a case where the specific component is an electric appliance (refrigerator, water purifier, or the like) driven at normal times, the total operation time may be understood as a time approaching a target set for performing the function of the specific component. For example, the set target may be a target temperature, a target amount of ice produced, or a target amount of clean water in the refrigerator.

The total operation time may be increased as compared with the operation time set before the output of the specific component is decreased. In a case where the output of the specific component is not decreased, the total operation time may be increased as compared with the operation time of the specific component. However, although the total operation time of the specific component is increased, the specific component is controlled so that the total energy cost generated through the drive of the specific component can be saved as compared with that when the output of the specific component is not decreased.

If the high-cost information is recognized, the output of the specific component may be increased.

However, although the output is increased at a point of time when the high-cost information is recognized, the total output of the specific component during the entire driving period may be decreased or maintained as compared with that when the specific component is operated under a normal output. Alternatively, although the output is increased at a point of time when the high-cost information is recognized, the total power consumption or total time-based pricing of the specific component during the entire driving period may be decreased as compared with that when the specific component is operated under the normal output.

If the low-cost information is recognized, the output of the specific component may be increased. For example, in a case where the operation reservation of the specific component is set up, the driving of the specific component may be started before the setup time, or a component having a large output in a plurality of components may be first driven. In a case where the specific component is a refrigerator, supercooling may be performed by increasing an output as compared with the existing output. In a case where the specific component is a washing machine or a washer, hot water may be stored by driving a heater earlier than the time when the heater is to be operated. Alternatively, in a case where the specific component recognizes an off-peak signal (e.g., at a point of time of recognition), electricity may be stored.

Meanwhile, in a case of a specific condition (additional condition) is generated based on the information related to the fluctuation of the energy cost (high-cost or low-cost information), the response of the specific component, e.g., the output control for power saving driving, may be limited. That is, the output of the specific component may be maintained.

Here, the term “limitation” may be understood as the release of the output control performed or not performed.

The specific condition includes a case where influence on energy cost is minute even though the output control of the specific component is not performed or a case where it is necessary to prevent a function to be performed by the specific component from being degraded when the output of the specific component is controlled.

Whether or not the influence on the energy cost is minute may be determined based on a predetermined reference (time-based pricing, power consumption or information on operation time). The predetermined reference may be a relative or absolute value.

The case where the function to be performed by the specific component is degraded may be considered as a case where the specific component is a defrosting heater, for example.

In a case where it is controlled to decrease the output in a high-cost time period and to increase the output in the low-cost time period, the driving of the defrosting heater is more frequently performed than that during a normal time (setup period). In this case, the temperature of a storage room in the refrigerator is increased, and thus, the control of the output can be limited.

Meanwhile, the specific component 30 may include a display unit 31 for displaying information. In this embodiment, the term “information display” means that visual, auditory, olfactory, and tactile information is known to the outside.

Also, the display unit 31 may include a touch screen for selecting or inputting information. Alternatively, the specific component 30 may include a separate input unit for inputting information by cable or radio.

All the information (energy information or additional information except the energy information) described above may be displayed on the display unit 31. One of the energy information and additional information may be displayed, or two or more pieces of information may be simultaneously displayed. That is, two or more pieces of information may be simultaneously displayed on the display unit 31. As an example, in a case where two or more pieces of information are simultaneously displayed, any one of the information is selected. Then, the selected screen may be enlarged, and the unselected screen may be reduced. For another example, if any one of the two or more pieces of information is selected, the selected screen may be enlarged, and the unselected screen may be disappear. In a case where specific information is selected and the selected screen is enlarged, information more specific than the previous information or information different from the previous information may be displayed on the enlarged screen. For example, in a case where the selected information is character, graphic information may be displayed on the enlarged screen. Alternatively, two or more pieces of information may be sequentially displayed on the enlarged screen. In a case where two or more pieces of information are displayed on the display unit 31, two or more relative positions may be varied.

Information except energy charge information and energy charge may be displayed on the displayed unit 31. The energy charge information may include current charge, past charge, or estimated charge in the future. The energy charge information may include not only information on charge information in a specific period or time but also information on charge used with respect to the operation of a component, charge used in the present, charge to be used (estimation charge), or the like.

The information except the energy charge information may include information on energy reduction, emergency situation, grid safety, power generation quantity, operation priority, energy consumption, energy supply amount, information (e.g., charge change rate, average charge, level or the like) newly generated based on two or more pieces of information (one or more pieces of energy charge information and/or information except the one or more pieces of energy charge information), and the like. Here, the energy consumption may be energy consumption used two or more home area networks, and may be simultaneously or selectively displayed.

The information on energy consumption may include information on past consumption, current consumption and estimated consumption in the future. The information on energy consumption may include information on accumulated consumption for a specific period (time), average consumption, increasing rate of consumption, decreasing rate of consumption, maximum consumption, minimum consumption, and the like.

The additional information may include one or more of environment information, time information, information related to the one or more components, information related to another component, and information related to a user using the one or more components. The environment information may include one or more of information related to carbon dioxide emission rate, concentration of carbon dioxide in air, temperature, humidity, precipitation, presence of rainfall, amount of solar radiation, amount of wind. The time information may include one or more of current time information, time information related to energy, and information related to an operation of the one or more components.

In addition to the information described above, information refined based on at least one information or newly generated information may also be displayed on the display unit 31.

In a case where the specific component 30 is the energy storage component 13 or 23, the presence of use of the stored electricity, the remaining amount of the store electricity and the like may be displayed. If the remaining amount of the stored electricity is less than a predetermined value, alarm information may be displayed.

The information displayed in the display unit 31 may include one or more of information on number, character, sentence, figure, shape, symbol, image and light. The information displayed in the display unit 31 may include one or more of information on graph for each time or period, level, table. One or more of the shape, color, brightness, size, position, alarm period, alarm time of the information displayed in the display unit 31 may be varied.

A currently operable function (or menu) may be displayed in the display unit 31. Alternatively, among a plurality of functions, operable and inoperable function may be divided by size, color, position and the like, and then displayed on the display unit 31. Alternatively, in a case where separate input units are provided, only an input unit for selecting an operable function may be activated, or an input unit for selecting an operable function and an input unit for selecting an inoperable function may be displayed in different colors. The target or display method of information displayed in the display unit 31 may be set and changed by a user, or may be changed automatically.

In a case where a condition for informing the user of information is satisfied, specific information may be displayed in the display unit 31. It will be apparent that a portion of plural pieces of information may be continuously displayed in the state that a component is turned on. The display time of the information may be changed or set automatically or manually.

If specific information (one or more pieces of information) is selected using the input unit, the selected information may be displayed. If a user contacts a portion of a component, e.g., an input unit, a handle, a display or the like, regardless of information display selection, or operates one or more buttons or knobs that constitute the input unit, a portion of the information may be displayed. In this instance, the information to be displayed may be set or changed. It will be apparent that a sensing unit for sensing a user's contact may be provided to the component. Alternatively, the specific information may be displayed by installation environment or variation of outdoor environment. Alternatively, the specific information may be displayed when the specific component receives new information. Alternatively, the specific information may be displayed when the kind or state of the specific component is changed. As an example, if a light emitting unit is turned off in an off-peak period and an on-peak period comes, the light emitting unit may be turned on. Alternatively, the specific information may be automatically displayed when the operation or state of the component is changed. As an example, in a case where the mode of the component is changed, information related to the changed mode may be automatically displayed.

Meanwhile, the display unit 31 may be separably connected or fixed to the component 30. In a case where the display unit 31 is separable from the component 30, it may perform wired or wireless communication with the component 30 (that may be a control unit of the component). In a case where the display unit 31 is fixed to the component 30, it may also perform wired or wireless communication with the component 30.

In a case where the display unit 31 is separable from the component 30, a communication unit and an input unit for inputting or selecting information may be provided to the display unit 31. Thus, information can be inputted or selected through the input unit in the state that the display unit 31 is separated from the component 30. The communication unit may be provided to the component 30, and only the display unit 31 may be separated from the component 30. The display unit 31 may be the energy management component 24, the energy metering component 25 or the central management component 27, or may be a separate control apparatus.

In a case where the display unit 31 is provided with a communication unit, a communication unit may also provided to the component 30. In a case where the display unit 31 and the component 30 are in the state that they are communicated with each other and information is transmitted/receive through a communication signal, the display unit 31 may be used. That is, in a case where the intensity of a signal is secured so that information can be included in the communication signal, the display unit 31 may be in an available state. On the other hand, in a case where the display unit 31 is not communicated with the component 30 or information is not included in the communication signal due to the weak intensity of the signal, the display unit may be in an unavailable state. One of the display unit 31 and the component 30 transmits a communication signal, and the other of the display unit 31 and the component transmits a response signal. The presence of use of the display unit 31 may be determined by the presence of reception of the communication and response signals and the signal intensity. That is, in a case where any one of the display unit 31 and the component 30 does not receive a signal or the intensity of received signal is less than reference intensity, it may be determined that the display unit 31 is unavailable. Any one of the display unit 31 and the component 30 may increase the intensity of a transmission signal until it receives a response signal of which intensity is more than the reference intensity.

Information for informing the user of the presence of use of the display unit 31 may be displayed in the display unit 31 or the component 30. If it is recognized that the display unit 31 is unavailable, the component 30 may be controlled to increase its unique performance, to perform a door locking function or to limit its operation. Alternatively, the power of the component may be off while maintaining the power of a communication apparatus (modem) required for performing communication in the network system. Alternatively, the power of the component may be turned off while maintaining only a memory function for storing the state information of the component.

Meanwhile, sensors may be provided to the respective display unit 31 and component 30 so as to sense the presence of mounting of the display unit 31. As an example, the presence of mounting of the display unit 31 may be determined when the component 30 is operated. Each of the sensors may be a vibration sensor for sensing vibration. If the display unit 31 is mounted on the component 30, vibration generated in the operation of the component 30 can be transferred to the display unit 31. Therefore, in a case where the difference between the values of vibrations respectively sensed by the sensors is less than a predetermined value, it may be recognized that the display unit 31 is mounted on the component 30. If it is recognized that the display unit 31 is mounted on the component 30, the operation of the component 30 may be controlled so that vibration or noise generated in the operation of the component 30 is decreased.

As an example, in a case where the component 30 is a washing machine or drier, the rotation speed of a motor may be decreased. In a case where the component 30 is a refrigerator, the driving period of a compressor may be decreased. On the contrary, if it is recognized that the display unit 31 is separated from the component 30, the component may be controlled to increase its unique performance, to perform a door locking function or to limit its operation.

As another example, each of the sensors may be a temperature sensor. In a case where the difference between the values of temperatures respectively sensed by the sensors is less than a predetermined value, it may be recognized that the display unit 31 is mounted on the component 30.

In the state that the display unit 31 is separated from the component 30, an auxiliary display unit may be provided to the component 30 so as to enable the operation of the component 30. The presence of operation of the auxiliary display unit may be determined based on the presence of use of the display unit 31. As an example, if the display unit 31 is separated from the component 30 or is unavailable, the auxiliary display unit may be turned on.

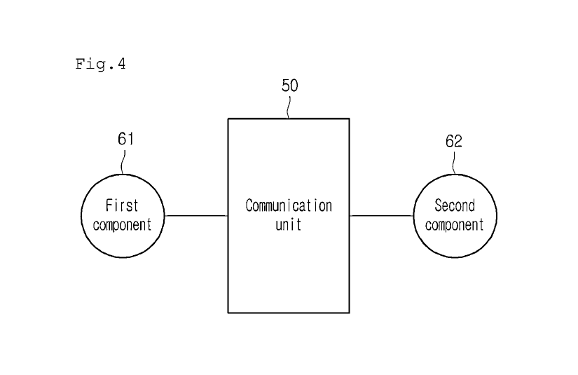

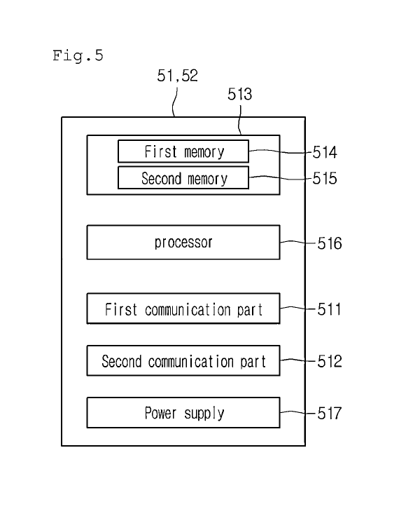

FIG. 4 is a view showing the communication structure of two components that constitute the network system according to a first embodiment. FIG. 5 is a block diagram showing the detailed configuration of a communication device that constitutes a communication unit.

Referring to FIGS. 2, 4 and 5, first and second component 61 and 62 that constitute the network system may perform wired or wireless communication by means of a communication unit 50. The first and second components 61 and 62 may perform unidirectional or bidirectional communication.

In a case where the two components 61 and 62 perform wired communication, the communication unit 50 may be a simple communication line or power line communication means. It will be apparent that the power line communication means may include communicators (e.g., a modem or the like) respectively connected to the two components.

In a case where the two components 61 and 62 perform wireless communication, the communication unit 50 may include a first communicator 51 connected to the first component 61 and a second communicator 52 connected to the second component 62. In this case, the first and second communicators 51 and 52 perform wireless communication with each other.

As an example, if any one of the first and second comunicators is powered on, one of the two communicators may transmit a network participation request signal, and the other of the two communicators may transmit a permission signal. As another example, if any one of the first and second comunicators is powered on, the powered-on communicator may transmit a network participation request signal to a communicator previously participated in the network, and the communicator that receives the request signal may transmit a permission signal to the powered-on communicator.

In a case where a communicator that recognizes energy information determines that an error occurs in the received information in the state that a specific component participates in the network, the information is re-requested. For example, in a case where the first communicator receives energy information from the second communicator but an error occurs in the received information, the first communicator may request the second communicator to re-transmit the energy information. If the first communicator does not receive normal information for a predetermined time or number of times, it is determined that the first communicator has an error. In this case, information for informing a user of the error may be displayed in the first communicator or the first component 61.

The first component 61 may be a component that constitutes the UAN 10 or a component that constitutes the HAN 20.

The second component 62 may be a component that constitutes the UAN 10 or a component that constitutes the HAN 20.

The first and second components 61 and 62 may be the same kind of component or different kinds of components.

Components may be joined in the UAN 10 or the HAN 20.

Specifically, addresses may be assigned to a plurality of components, e.g., first and second components, respectively. Here, the addresses are necessary for performing communication between the components and can be mapped to at least a group.

The address may be understood as values respectively converted from the unique code of the first or second component. That is, at least a portion of the components that constitute the network system may have an unchangeable/unique code, and the code may be converted into an address for building a network.

In other words, product codes for at least some of the plurality of components capable of constituting first and second networks may be converted into different network codes based on the constituted networks.

As an example, the product code may be a unique code determined in production of electric appliances or a code separately provided for the registration of a network. The product code may be converted into an identity (ID) for identifying a network to which the electric appliance is to be registered.

The first and second networks may be networks that constitute the UAN 10 or networks that constitute the HAN 20. On the other hand, the first and second networks may be the UAN 10 and the HAN 20, respectively. Alternatively, the first and second networks may be the HAN 20 and the UAN 10, respectively.

A first component and a second component for allowing the first component to participate in the network may be included in the plurality of components that constitute the network. For example, the first component may be an electric appliance and the second component may be a server.

Any one of the first and second components transmits a request signal for participating in the network, and the other of the first and second components may transmit a permission signal.

That is, a signal may be transmitted/received between the first and second components, and whether or not to participate in the network may be determined based on the transmission time or number of the signal.

As an example, the first component transmits a test signal to the second component, and it is determined whether or not a response signal from the second component is transmitted to the first component. In a case where the response signal is not transmitted, the first component re-transmits the test signal, and it is re-determined whether or not a response signal from the second component is transmitted to the first component. By repeating such a process, if the transmission number of the test signal exceeds the setting number of the test signal, it may be determined that the second component does not participate in the network.

Meanwhile, the first component may transmit the test signal to the second component. If a response signal from the second component is not transmitted within a setup time, it may be determined that the second component does not participate in the network.

The first and second communicators 51 and 52 may have the same structure. Hereinafter, the first and second communicators 51 and 52 will be referred to as a communicator 51 and 52.

The communicator 51 and 52 may include a first communication part 511 for communication with the first component 61, a second communication part 512 for communication with the second component 62, a memory 513 for storing information received from the first component 61 and information received from the second component 62, a processor 516 for performing information processing, and a power supply 517 for supplying power to the communicator 51 and 52.

Specifically, the communication language (or scheme) of the first communication part 511 may be identical to or different from that of the second communication part 512.

Two kinds of information respectively received from the two components may be stored in the memory 513. The two kinds of information may be stored in a single sector or may be respectively stored in sectors. In any case, an area in which the information received from the first component 61 may be referred to as a first memory 514, and an area in which the information received from the second component 62 may be referred to as a second memory 515.

The processor 516 may generate first information or generate second and third information based on information received from the component or another communicator.

As an example, in a case where the communicator 51 and 52 receives the first information, it may generate information or sequentially generate the information and the second information by processing a data. Alternatively, in a case where the communicator 51 and 52 receives the first information, it may generate the second and third information by processing a data. In a case where the communicator 51 and 52 receives the third information, it may new third information.

For example, in a case where the second component is an energy consumption component (electric home appliance, component that constitutes the electric home appliance, or the like), the second communicator may generate a command for reducing energy consumption. In a case where the second component is an energy generation component, energy distribution component or energy storage component, the second communicator 52 may generate a command for energy generation time, generation amount, energy distribution time, distribution amount, energy storage time, storage amount or the like. In this case, the second communicator 52 serves as an energy management component.

The power supply 517 may receive electricity supplied from the components 61 and 62 or may receive electricity supplied from a separate power source. Alternatively, the power supply 517 may be a battery or the like.

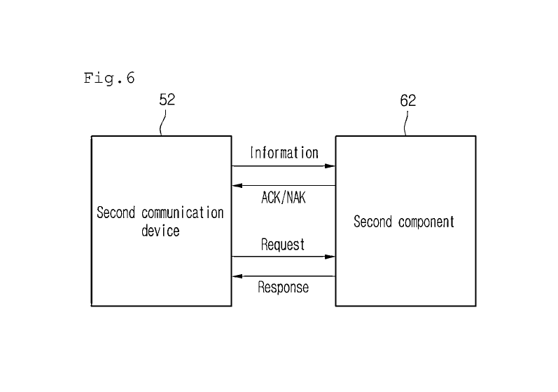

FIG. 6 is a view showing a communication performing process between a specific component and a communication device according to the first embodiment.

Hereinafter, for convenience of illustration, a communication performing process between the second component and the second communicator 52 will be described as an example. A communication performing process between the first component 61 and the first communicator 51 may be identically applied to that between the second component 62 and the second communicator 62.

Referring to FIGS. 5 and 6, the second communicator receives a message from the first communicator 51. The second communicator 52 may receive a message in real time or by periods without transmitting a request for the message to the first communicator 51, or may receive a message as a response for the request for the message to the first communicator 51. Alternatively, the second communicator 52 may receive a message by requesting information to the first communicator 51 at a point of time when it is initially turned on. Then, the second communicator 52 may receive information in real time or by periods from the first communicator 51 without a request for information.

The information received from the first communicator is stored in the memory 513. The second communicator 52 transmits a message to the second component 62 as a response for the message. In this instance, the message transmitted to the second component 62 relates to new information different from the information previously stored in the memory 513, or information generated in the processor 516.

Then, the second component 62 transmits an acknowledge character (ack) or negative acknowledge character (Nak) to the second communicator 52 as a response for the message. The second component 62 performs a function (generation of a command, operation, or the like) based on the received information, or waits for performing the function.

Meanwhile, the second communicator 52 requests component information to the second component 62 in real time or by periods. As an example, the component information may be component state information or information on a component unique code, a manufacturer, a service name code, an electricity use amount, and the like. Then, the second component 62 transmits component information to the second communicator 52 as a response for the request. The component information is stored in the memory 513 of the second communicator 52.

If the second communicator 52 receives a message for requesting the component information from the first communicator 51, it transmits the component information stored in the memory 513 to the first communicator 51 as a response for the message. Alternatively, the second communicator 52 transmits the component information stored in the memory 513 to the first communicator 51 in real time or by periods.

The second communicator 52 may transmit the information of the first component, stored in the memory, to the first component together with the information received from the first component. Alternatively, the second communicator 52 may transmit the information of the first component, stored in the memory, to the first component, separately from transmitting the information received from the first component.

The second communicator 52 stores the information of the second component 62 in the memory 513. Hence, in a case where the second communicator 52 receives a message for requesting the component information from the first communicator 51, it transmits the component information stored in the memory 513 directly to the first communicator 51 without a request for information to the second component 62, and thus, the communication load of the second component 62 can be reduced. That is, the second component becomes a virtual component.

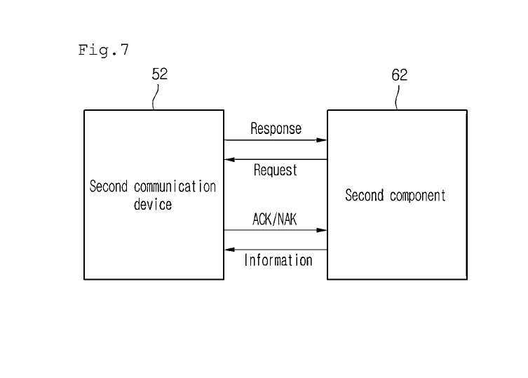

FIG. 7 is a view showing a communication performing process between a specific component and a communication device according to a second embodiment.

Hereinafter, for convenience of illustration, a communication performing process between the second component and the second communicator 52 will be described as an example. A communication performing process between the first component 61 and the first communicator 51 may be identically applied to that between the second component 62 and the second communicator 62.

Referring to FIGS. 5 and 7, the second communicator receives a message from the first communicator 51. The second communicator 52 may receive a message in real time or by periods without transmitting a request for the message to the first communicator 51, or may receive a message as a response for the request for the message to the first communicator 51. Alternatively, the second communicator 52 may receive a message by requesting information to the first communicator 51 at a point of time when it is initially turned on. Then, the second communicator 52 may receive information in real time or by periods from the first communicator 51 without a request for information.

If the second communicator 52 receives a message for requesting information from the second component 62, it transmits a message to the second component 62 as a response for the message for requesting the information. In this instance, the message transmitted to the second component 62 relates to new information different from the information previously stored in the memory 513, or information generated in the processor 516. Alternatively, the information transmitted to the second component 62 may be information received from the first component.

The second component 62 performs a function based on the received information or waits for performing the function.

Meanwhile, the second component 62 transmits component information to the second component 62 in real time or by periods. As an example, the component information may be component state information or information on a component unique code, a manufacturer, a service name code, an electricity use amount, and the like.

As described above, the electric use amount may be detected by the smart meter. In a case where the electricity use amount is included in the information of the second component 62, the correction of an actual electricity use amount may be performed by comparing the information of the second component 62 with the information of the smart meter.

Then, the second communicator 52 stores the information of the second component 62 in the memory 513, and transmits an acknowledge character (ack) or negative acknowledge character (Nak) to the second component 62 as a response for the message.

If the second communicator 52 receives a message for requesting component information from the first communicator 51, it transmits the information of the second component 62, stored in the memory 513, to the first communicator 51 as a response for the message. Alternatively, the second communicator 52 the information of the second component 62, stored in the memory 513, to the first communicator 51 in real time or by periods.

The second communicator 52 stores the information of the second component 62 in the memory 513. Hence, in a case where the second communicator 52 receives the message for requesting the component information from the first communicator 51, it transmits the information stored in the memory 513 directly to the first communicator 51 without transmitting a request for information to the second component 62, and thus, the communication load of the second component 62 can be reduced. That is, the second communicator 52 becomes a virtual component.

<Applications>

In the following descriptions, the first and second components may be reversed to each other, and therefore, overlapping descriptions will be omitted. For example, in a case where the first component is an electric home appliance and the second component is an energy management component, description in a case where the first component is an energy management component and the second component is an electric home appliance will be omitted.

Information transmitted/received by each of the components may be all the information described above. Particularly, specific information may be transmitted/received for each of the components.

The energy generation components 11 and 21 may transmit/receive information related to energy generation amount, and the like. The energy distribution components 12 and 22 may transmit/receive information related to energy distribution amount, distribution time, and the like. The energy storage components 13 and 23 may transmit/receive information related to energy storage amount, storage time, and the like. The energy metering components 15 and 25 may transmit/receive information related to energy consumption amount, and the like. The energy management components 14 and may transmit/receive information related to energy generation, distribution, storage, consumption, cost, reliability, emergency situation, and the like.

(1) Case where Second Component is One Component of HAN

The second component 62 may be an energy consumption component 26, e.g., a heater, motor, compressor, display or the like. In this case, the first component 61 may be a MICOM or energy consumption component 26 as an example. The MICOM or energy consumption component 26 may transmit a message for reducing energy consumption to another energy consumption component 26. Then, the another energy consumption component 26 may perform an operation for reducing energy, for example.

As another example, the energy consumption component 26 may be an electric home appliance. In this case, the first component 61 may be an energy storage component 23, an energy consumption component 26 (electric home appliance), an energy management component 24, an energy metering component 25, a central management component 27, a web server component 28, or a component that constitutes the UAN 10.

In this instance, an energy management function may be included or not included in the first component 61 except the energy management component 24.

In a case where an energy management function or solution is not included in the first component 61, it may be included in the communication unit or may be included in the MICOM of the second component 62. In this case, the energy management function is related to the consumption of energy.

As still another example, the second component 62 may be an energy generation component 21, an energy distribution component 22 or an energy storage component 23. In this case, the first component 61 may be an energy management component 24, a central management component 27, a web server component 28 or a component that constitutes the UAN A message may be transmitted to the second component 62. Here, the message may include energy generation time, generation amount or the like, energy distribution time, distribution amount or the like, and energy storage time, storage amount or the like.

In this instance, an energy management function may be included or not included in the first component 61 except the energy management component 24.

In a case where an energy management function or solution is not included in the first component 61, it may be included in the communication unit. In this case, the energy management function is related to the generation, distribution and storage of energy.

As still another example, the second component may be an energy metering component 25. In this case, the first component 61 may be a central management component 27, a web server component 28 or a component that constitutes the UAN 10.

An energy management function may be included or not included in the energy metering component. In a case where the energy management function is included in the energy metering component 25, the energy metering component 25 performs the same operation as the EMS.

In a case where an energy management function or solution is included in the energy metering component 25, it may be included in the communication unit or may be included in the second component 62.

As still another example, the second component 62 may be a central management component 27. In this case, the first component 61 may be a web server component 28 or a component that constitutes the UAN 10.

(2) Case where Second Component is One Component of UAN

The first component 61 may be a component that constitutes the UAN 10. In this case, the first and second components 61 and 62 may be the same kind of component or different kinds of components.

An energy management function may be included in the first component 61, the second component 62 or the communication unit.

The energy management function included in a specific component or the energy management function included in the energy management component 14 may be related to generation amount, distribution amount, storage amount, energy use amount of a component that constitutes the HAN 20.

In this specification, an example capable of constituting the network system has been described. However, any component not mentioned in this specification may be a first or second component that performs communication through the communication unit. For example, an automobile may be a second component, and the energy management component 24 may be a first component.

(3) Case where One of First and Second Components Communicates with Third Component

Although the communication between two components has been described in the aforementioned examples, each of the first and second components may perform communication with one or more components (a third component to an n-th component).

In this case, the relation of the first or second component that performs communication with the third component and the like may be one of the aforementioned examples.

For example, the first component may be a component that constitutes the UAN, the second component may be an energy management component 24 that communicates with the first component, and the third component may be an energy consumption component 26 that communicates with the second component. In this instance, one or more of the three components may communicate with another component.

In this specification, the first to n-th components may be components that constitute the UAN or components that constitute the HAN. Alternatively, a portion of the components may be components that constitute the UAN, or another portion of the components may be components that constitute the HAN.

Hereinafter, third and fourth embodiments will be described. A difference between these embodiments and the aforementioned embodiments will be mainly described, and descriptions and reference numerals will be quoted to elements of these embodiments identical to those of the aforementioned embodiments.

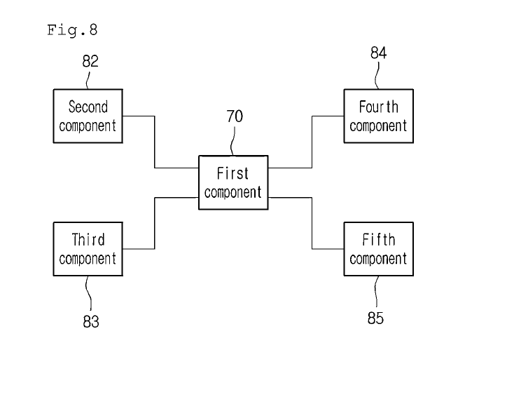

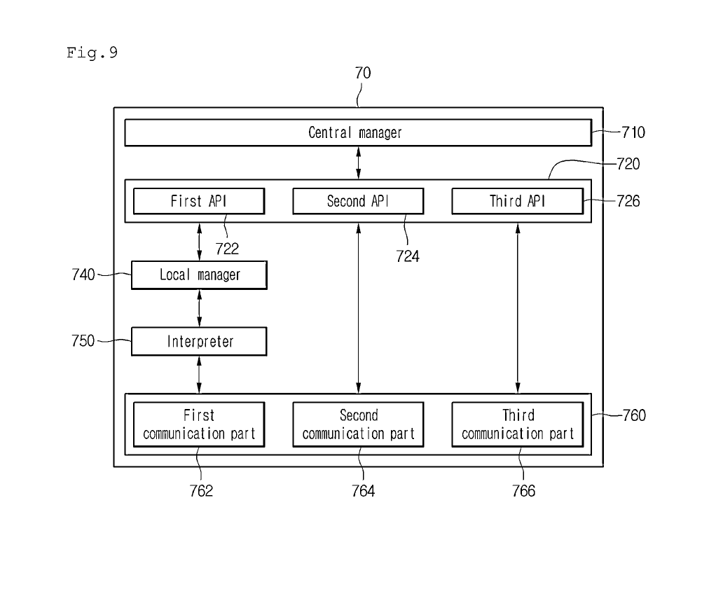

FIG. 8 is a view showing the communication structure of components that constitute the network system according to a third embodiment. FIG. 9 is a block diagram showing the detailed configuration of a first component in FIG. 8.

Referring to FIGS. 8 and 9, a first component 70 may communicate with second to fifth components 82, 83, 84 and 85. Hereinafter, it will be described as an example that the first component 70 is a central management component (home server), the second and third components 82 and 83 are energy consumption components (electric home appliances), the fourth component 84 is an energy metering component (smart meter), and the fifth component 85 is a component that constitutes the UAN. The components may communicate with each other by means of a communication unit. In the network system illustrated in FIG. 8, each of the components is directly connected to the first component 70 to communicate with the first component 70. However, in a case where each of the components 82, 83, 84 and 85 is connected to new components to communicate with the new components, the network system may be extended and operated by the new components.

The second and third components 82 and 83 may be the same kind of component or different kinds of components. In this embodiment, it will be described as an example that the second and third components 82 and 83 are different kinds of energy consumption components.

The first component 70 may simply transmit information received from the fourth component 84 and/or the fifth component 85 to the second component 82 and/or the third component 83, or may process the received information and transmit the processed information.

The first component 70 may simply transmit information received from the second component 82 and/or the third component 83 to the fourth component 84 and/or the fifth component 85 (a signal may be converted), or may process the received information and transmit the processed information (the information is converted.

The first component 70 includes a communication unit 760 for performing communication with another component, a central manager 710 for managing the entire operation and/or information processing of the first component, and an application programming interface 720 (hereinafter, referred to as an API) for performing an interface between the communication unit 760 and the central manager 710 (specifically, application software).

The communication unit 760 includes a first communication part 762 for performing communication with the second and third components 82 and 83, a second communication part 764 for performing communication with the fourth component 84, and a third communication part 766 for performing communication with the fifth component 85.

In this instance, the first and second communication parts 762 and 764 may use different communication protocols from each other. As an example, the first communication part 762 may use Zigbee and the second communication part 764 may use Wi-fi. In this embodiment, the kind of communication protocol or method used by the first and second communication parts 762 and 764 is not limited. The third communication component 766 may use Internet communication as an example.

The API 720 includes a first API 722, a second API 724 and a third API 726. The third API 726 is an interface between the central manager 710 and the third communication part 766, and the first API 722 is an interface between the first communication part 762 and the central manager 710. The second API 724 is an interface between the second communication part 762 and the central manager 710.

The first component 70 further includes a local manager 740 and an interpreter 750. In a case where the information to be transmitted/received between the API 720 and the communication unit 760 is information related to operations of energy consumption components (electric home appliances), the local manager 740 outputs information corresponding to the respective energy consumption components. The interpreter 750 interprets information transmitted from the local manager 740 to the communication unit 760 or information received in the communication unit 760. The information outputted from the interpreter 750 is used to set or get values of information related to the respective energy consumption components.

The local manager 740 includes a memory (not shown) in which information related to one or more energy consumption components is stored. Alternatively, the local manager 740 may be connected to a memory in which information related to one or more energy consumption components is stored. The information related to each of the energy consumption components may include operation information of each of the energy consumption components and information for controlling the energy consumption components. The information related to each of the energy consumption components may further include software download information for operating each of the energy consumption components and information for remote controlling/monitoring.

As an example, in a case where a plurality of energy consumption components include a washing machine, a refrigerator and a cooking appliance, information related to each of the energy consumption components is stored in the memory. The information related to each of the energy consumption components may be changed as components connected to the network system are changed.

If a signal is transmitted from the API 720 to the local manager 740, information corresponding to a specific energy consumption component is outputted. In a case where a plurality of energy consumption components exist, information on the plurality of energy consumption components is outputted. The interpreter 750 interprets the information transmitted from the local manager 740 into a machine language so as to transmit the information to the energy consumption components. The machine language may be a signal used to set or get the operation information of the energy consumption components.

The information transmission process in the first component 70 will be described.

As an example, the first component 70 may receive energy information (e.g., an energy reduction signal: first command) from the forth component 45 through the second communication part 764. The received energy information is transmitted to the central manager 710 through the second API 724. In the process of information transmission between the second API 724 and the central manager 710, only a signal including the information is converted, and the content of the information is not converted.

Since the energy information is information related to the energy consumption reduction of the energy consumption components, the central manager 710 transmits information (second command) related to operations of the energy consumption components to the API 720. As an example, the central manager 710 transmits information necessary for turning off power of the washing machine or refrigerator.

Then, the information is transmitted from the first API 722 to the local manager 740.

The local manager 740 transmits information (third command) for controlling the operation of each of the energy consumption components to the interpreter 750 based on the information transmitted from the first API 722. As an example, in a case where the information transmitted from the first API 722 is information having different kinds of energy consumption components as targets, the local manager 740 transmits information related to the control of each of the energy consumption components to the interpreter 750. In this case, since the local manager 740 receives the second command and outputs the third command, the information inputted to the local manager 740 is converted and outputted by the local manager 740.

Subsequently, the interpreter 750 interprets the information transmitted from the local manager 740 into a machine language (signal). Then, the converted signal is transmitted to the target energy consumption components (second and third components) through the first communication part 762. Then, the energy consumption components (second and third components) are finally turned off so as to reduce energy.

Although it has been described above that the first component receives information through the second communication part, the first component may receive information through the third component so that the information related to the energy consumption components is outputted.

Meanwhile, the second and third components 82 and 83 may transmit their own operation information to the first component 70. Since the information transmitted from the second and third components 82 and 83 is information related to operations of the energy consumption components, the signal received in the first communication part 762 is transmitted to the central manager 710 via the interpreter 750, the local manager 760 and the first API 722. In such an information transmission process, the information related to the second and third components 82 and 83 is stored in the local manager 740. In this embodiment, since the information related to the energy consumption components is stored in the local manager, the local manager may be understood as a virtual energy consumption component (abstraction model).

The central manager 710 may transmit the received information to the second communication part 764 and/or the third communication part 766.

The operation of the first component will be described. The information received through the communication unit 760 may be transmitted directly to the API 720, or may be converted (via the interpreter and the local manager) and then transmitted to the API 720, based on the kind of information (or the type of signal).

The information transmitted from the central manager 740 may be transmitted directly to the communication unit 760, or may be converted and then transmitted to the communication unit 760.

As another example, the interpreter may be included in the local manager 740, and the information received through the communication unit 760 is transmitted to the local manager 740. However, converted information may be outputted, or information may be outputted as it is without converting the information.

Meanwhile, in a case where the information transmitted to the API 720 through the second or third communication part 764 or 766 is information (raw data or refined data) related to time-based pricing, the central manager 710 determines the presence of on-peak time. In the case of the on-peak time, the central manager 710 may transmit the information (first command) for controlling the operations of the energy consumption components to the API 720. Then, the information is converted through the local manager 740, and the converted information (second command) is transmitted to the energy consumption components through the first communication part 762. Alternatively, the central manager 710 may transmit the information related to the time-based pricing to the first communication part 762 through the second API 724 without determining the presence of on-peak time. In this case, the information may be converted or not converted. That is, in a case where the central manager directly receives first information (raw data), it may transmit the first information as it is, or convert the first information into a second information (refined data) and then transmit the second information.

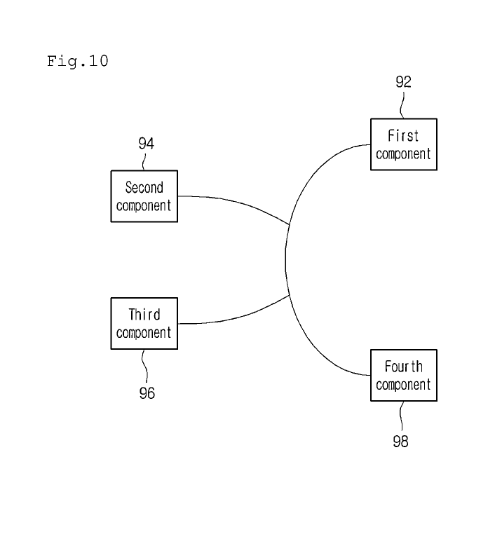

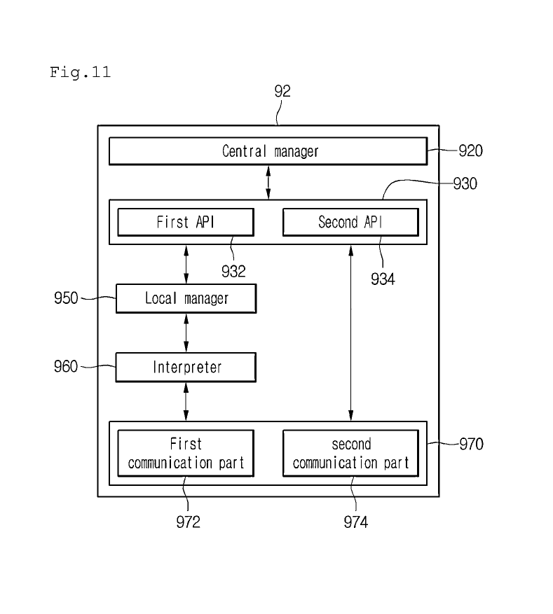

FIG. 10 is a view showing the communication structure of components that constitute the network system according to a fourth embodiment. FIG. 11 is a block diagram showing the detailed configuration of a first component in FIG. 10.

Referring to FIGS. 10 and 11, the network system of this embodiment may include at least first to fourth components 92, 94, 96 and 98.

The first component 92 may communicate with the second to fourth components 94, 96 and 98. The fourth component 98 may communicate with the first to third components 92, 94 and 96.

Hereinafter, it will be described as an example that the first component 92 is a central management component (home server), the second and third components 94 and 96 are energy consumption components (electric home appliances), and the fourth component 98 is an energy metering component (smart meter).

The central management component (home server) may be understood as a component necessary for controlling at least a component that constitutes the HAN 20.

The first component 92 includes a communication unit 970 for performing communication with another component, a central manager 920 for managing the entire operation and/or information transmission/reception of the first component 92, and an application programming interface 930 (hereinafter, referred to as an “API”) that serves as an interface between the communication unit 970 and the central manager 920 (specifically, application software).

The communication unit 970 may include a first communication component 972 for performing communication with the second to fourth components 94, 96 and 98, and a second communication component 974 for performing Internet communication.

The API 930 includes a first API 932 and a second API 934. The second API 934 is an interface between the central manager 920 and the second communication part 974, and the first API 930 is an interface between the first communication part 972 and the central manager 920.

The first component 92 further includes a local manager 950 and an interpreter 960. In a case where the information to be transmitted/received between the API 932 and the communication unit 970 is information related to operations of energy consumption components (electric home appliances), the local manager 950 outputs information corresponding to the respective energy consumption components. The interpreter 960 interprets information transmitted from the local manager 950 to the communication unit 970 or information received in the communication unit 970.

In this embodiment, the functions of the interpreter and the local manager are identical to those of the third embodiment, and therefore, their detailed descriptions will be omitted.

The information transmission process in the first component 92 will be described.

As an example, the first component 92 may receive energy information (e.g., energy reduction signal) from the fourth component 98 through the first communication part 972. Alternatively, the first component 92 may receive energy information from an external component connected to Internet through the second communication part 974.

The received energy information is transmitted directly to the first or second API 932 or 934 and then transmitted to the central manager 920. Since the energy information is information related to the energy consumption reduction of the energy consumption components, the central manager 920 transmits information related to the operations of the energy consumption components to the first API 932. As an example, the central manager 920 transmits information necessary for turning off power of a washing machine or refrigerator.

Then, the information is transmitted from the first API 932 to the local manager 950.

The local manager 950 transmits information for controlling the operation of each of the energy consumption components to the interpreter 960 based on the information transmitted from the first API 932. As an example, in a case where the information transmitted from the first API is information related to different kinds of energy consumption components, the local manager 950 transmits information related to the control of each of the energy consumption components to the interpreter 960.

Subsequently, the interpreter 960 interprets the information transmitted from the local manager 960 into a machine language (signal). Then, the interpreted signal is transmitted to the energy consumption components through the first communication part 972. Then, the energy consumption components are finally turned off so as to reduce energy.

Meanwhile, the second and third components 94 and 96 may transmit their own operation information to the first component 92. Since the information transmitted from the second and third components is information related to the operations of the energy consumption components, the signal received in the first communication part 972 is transmitted to the central manager 920 via the interpreter 960, the local manager 950 and the first API 932. In such an information transmission process, the information related to the first and second components is stored in the local manager 950.

The central manager 920 may transmit the received information to the first communication part 972. Then, the information of the second and third components 94 and 96 is transmitted to the fourth component 98.

The operation of the first component will be described. The information received through the communication unit 970 may be transmitted directly to the API 930, or may be converted (via the interpreter and the local manager) and then transmitted to the API 930, based on the kind of information (or the type of signal).

On the contrary, the information transmitted from the central manager 920 may be transmitted directly to the communication unit 970, or may be converted and then transmitted to the communication unit 970.

Meanwhile, in a case where the information transmitted to the API 930 through the second communication part 974 is information related to time-based pricing, the central manager 920 determines the presence of on-peak time. In the case of the on-peak time, the central manager 920 may transmit the information for controlling the operations of the energy consumption components to the API 930. Then, the information is transmitted to the energy consumption components through the local manager, the interpreter and the first communication part. In this case, the first component may be understood as an energy management component.

Although it has been described above that two energy consumption components communicate with the first component, the number of energy consumption components that communicate with the first component is not limited.

Although it has been described as an example that the first component is a home server, the first component may be an energy management component. In this case, the fourth component may be a central management component, an energy management component, a smart meter, or the like.

As another example, the first component may be a smart meter. In this case, the fourth component may be a central management component, an energy management component, or the like.

As still another example, the first component may be a terminal component (e.g., a gate way).

As still another example, each of the second and third components may be an energy generation component, an energy storage component or the like, which constitutes the HAN. That is, one or more of the energy generation component, the energy consumption component and the energy storage component may communicate with the first component. In addition to information related to the energy consumption component, information related to the energy generation component (e.g., information related to the operation of the energy generation component) and information related to the energy storage component (e.g., information related to the operation of the energy storage component) may be stored in the memory included in a local network or connected to the local network.

Although it has been described above that the first component performs Internet communication, the Internet communication may not be performed.

Although it has been described in the first embodiment that a single local manager is provided, a plurality of local managers may be provided. As an example, a first local manager may process information on an electric home appliance such as a refrigerator or washing machine, and a second local manager may process information on a display product such as a television or monitor.

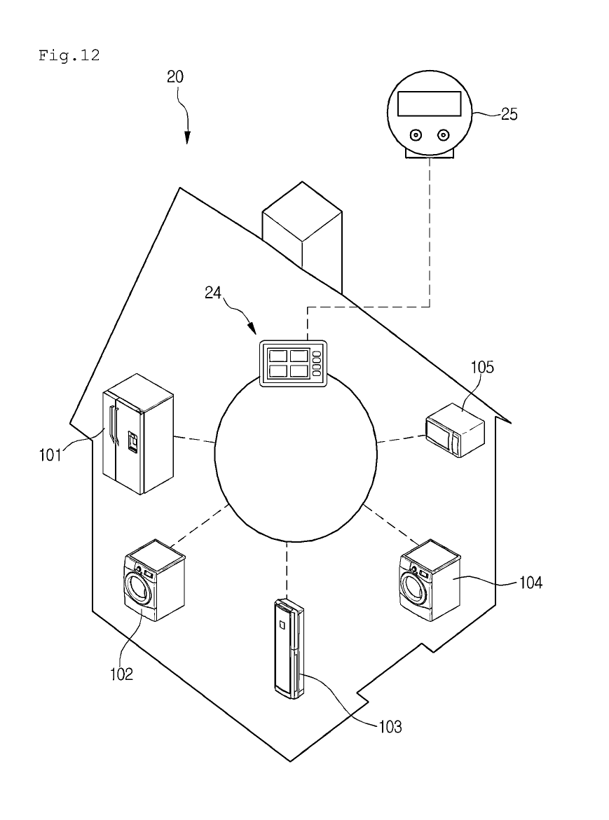

FIG. 12 is a schematic view of a home area network according to an embodiment.

Referring to FIG. 12, a home network 20 according to an embodiment may include an energy measurement unit 25 (e.g., a smart meter) capable of measuring the charge of power and/or electricity, being supplied to each home, in real-time from the utility network 10, and an energy management unit 24 connected to the energy measurement unit 25 and an electric product to control operations of the energy measurement unit 25 and the electric product.

The energy management unit 24 is connected to electric products, i.e., the energy consumption unit 26 such as a refrigerator 101, a washing machine 102, an air conditioner 103, a drier 104, or a cooking appliance through an in-house network for two-way communication.

In-house communication may be performed by wireless communication such as Zigbee, WiFi or the like or by wire communication such as power line communication (PLC). Furthermore, the electric products may be connected to each other so as to communicate with each other.

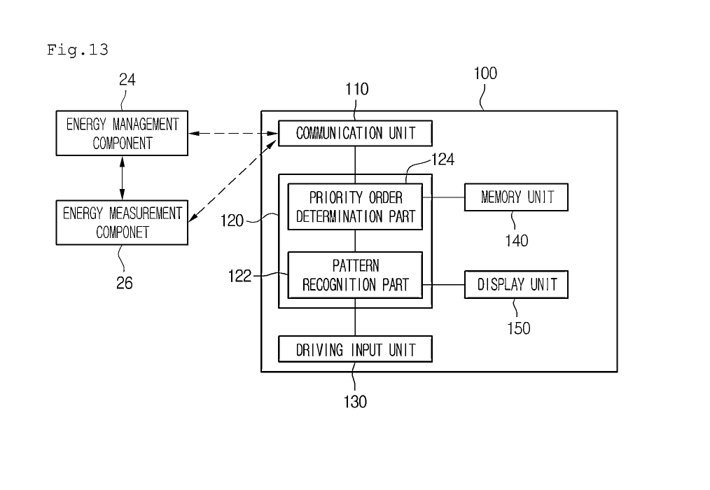

FIG. 13 is a block diagram of an energy consumption component constituting the home area network according to an embodiment.

Referring to FIG. 13, an energy consumption component 100 according to an embodiment includes a communication unit 110 for communicating with at least one of the energy management component 24 and/or the energy measurement component 25. The energy measurement component 25 and the energy management component 24 may communicate with each other. The communication component 110 may be provided in the energy consumption component 100 or be connected to the energy consumption component 100.

The energy consumption component 100 may include a driving input unit 130 for inputting a predetermined command to drive the energy consumption component 100, a memory unit 140 for interpreting the command inputted through the driving input part 130 to store predetermined information, a display unit 150 for displaying a driving state of the energy consumption component 100 or the predetermined information, and a control unit 120 for controlling the driving input unit 130, the memory unit 140, and the display unit 150.

In detail, the energy consumption component 100 is a component which can be driven with a predetermined pattern (a driving method) or manner (a course) according to the inputted command.

The driving input unit 130 may include a plurality of input units for performing the pattern (the driving method). For example, the driving input unit 130 may include input units for separately inputting A, B, C, and D commands into the energy consumption component for performing A, B, C, and D courses. On the other hand, the driving input unit may include a separate input unit for selecting a fixed (previously defined) course such as an A+B+C+D course. The present disclosure is not limited to the input method or kind of the driving input unit 130. When a user uses the energy consumption component, which performs a course (cycle) as a main function, several times or for a long time, a pattern (course) mainly used according to a driving habit of the user may be filtered. The control unit 120 may store driving information of a specific pattern mainly used by the user into the memory unit 140.

In detail, the control unit 120 includes a pattern recognition part 122 for recognizing a selected driving pattern according to a command inputted through the driving input unit 130 or by combining inputted commands. For example, the pattern recognition part 122 may recognize an A+B+C+D pattern, an A+B+C+E pattern, or the like with respect to each of A, B, C, and D operations constituting the driving courses of the energy consumption component 100. As described above, each of the A, B, C, and D commands may be inputted through the driving input unit 130, or the combined A+B+C+D or A+B+C+E course may be inputted through the preset input unit. Also, various selectable options with respect to the A, B, C, D, and E operations may be provided according to a driving time or method of the energy consumption component 100.

For example, when the energy consumption component 100 is a dryer that is an electric product, the options selectable by the user in a general course includes whether a my cycle mode (a mode driven on the basis of a frequently used pattern according to a user's habit) is selected, whether a safety mode (e.g., a child lock mode) is selected, a degree of an output intensity of a buzzer through the display unit; selection in a plurality of levels according to a drying degree, whether a pleat prevention mode is selected, or whether a delay operation is performed.

The control unit 120 may further include a priority order determination part 124 for determining a priority order of the pattern on the basis of a pattern (course) recognized by the pattern recognition part 122 and information (energy information and an additional information except the energy information) transmitted from the energy management component or the energy measurement component 25. The pattern recognition part 122 and the priority order determination part 124 may be provided as separate parts. Alternatively, the pattern recognition part 122 and the priority order determination part 124 may be provided in one body having different functions.

When the driven number of pattern recognized by the pattern recognition part 122 is greater than a preset number, the priority order determination part 124 determines a power consumption amount of the energy consumption component 100 according to the pattern. For example, a pattern having the lowest power consumption amount may be determined as a first priority order. The memory unit 140 may store a power consumption amount for each pattern determined by the priority order determination part 124.

The display unit 150 may display priority order information of a pattern at a time point at which an operation of the energy consumption component 100 starts, a time point at which the user inputs a specific command through the driving input unit, or a time point at which a specific mode (for example, a user pattern mode) is selected.

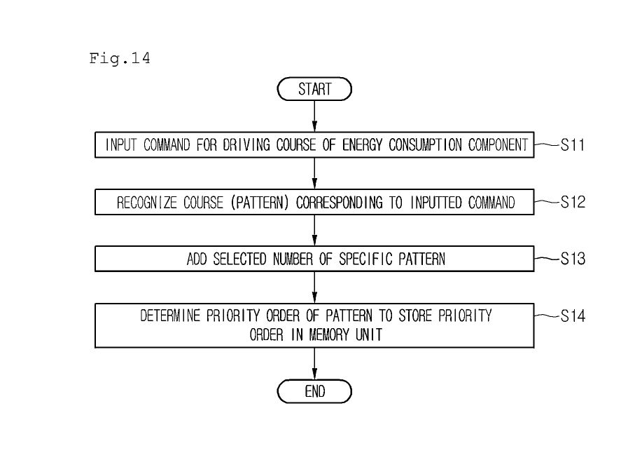

FIG. 14 is a flowchart illustrating an order of controlling a network system according to a first embodiment. FIG. 14 illustrates a control order for recognizing a frequently used pattern according to a driving pattern of an energy consumption component 100 to determine a priority order.

Referring to FIG. 14, a specific command may be inputted to select a course of the energy consumption component 100. As described above, the specific command may be inputted by a driving input unit 130 (S11).

Also, a course (a driving pattern) of the energy consumption component 100 corresponding to the inputted command may be recognized by a pattern recognition part 122 (S12).

The selected course information is transmitted into the priority order determination part 124. Then, the priority order determination part 124 adds (n=n+1) a selected number of the specific pattern on the basis of information stored in a memory unit 140. Also, the added specific pattern information (the selected number, a driving time of the selected pattern (course), and a power consumption amount of the selected pattern) may be stored again in the memory unit 140 (S13).

The priority order determination part 124 may determines a priority order of a pattern according to a specific reference (a few degree required for the power consumption amount or the energy charge) at a time point at which the energy consumption component 100 by comparing the information transmitted from a communication unit 110, for example, a high-price period information (e.g., a time at which an on-peak time period arrives or time period information) with the specific pattern information. The priority order information may be stored in the memory unit 140.

The control unit 120 performs a specific pattern according to the decided priority order (e.g., a first priority order) or allows a user to display the priority order information through a display unit 150.

When the priority order information is displayed, the user may select again the driving pattern of the energy consumption component 100 on the basis of the displayed information (S14).

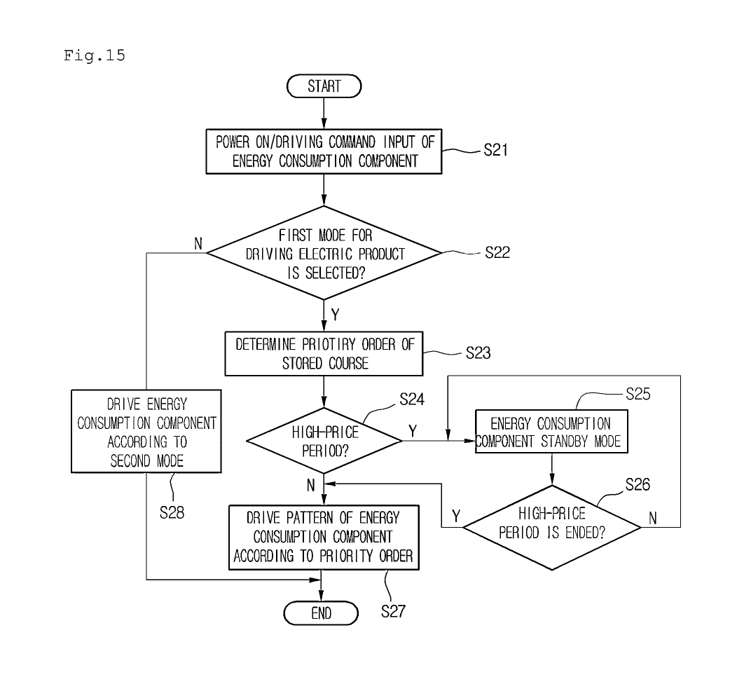

FIG. 15 is a flowchart illustrating a method of controlling the network system according to the first embodiment.

Referring to FIG. 15, the energy consumption component 100 may be turned on to input a specific driving command, thereby operating the energy consumption component 100. The specific command may include an automatic mode or a manual mode. The automatic mode may be a mode in which a control unit 120 selects an optimal pattern, and then the energy consumption component 100 is automatically driven according to the selected pattern on the basis of a previously stored user pattern and the information transmitted from the energy management component 24 or the energy measurement component 25. The automatic mode relates to a mode selection and driving depending on a user's habit (pattern). Thus, the automatic mode may be called a “user pattern mode” or “my cycle mode”. The manual mode may be a mode in which a driving pattern is selected by a manual command input of the user, i.e., an input of the driving input unit 130, and then the energy consumption component is driven according to the selected pattern.

However, in a case of the manual mode, the optimal pattern may be displayed or commended on the basis of the user pattern information stored in the memory unit 140 and the communicating information (S21). It is determined whether an inputted specific command is a first mode, i.e., the automatic mode (S22).

When the automatic mode is selected, a priority order of the user pattern (course) stored in the memory unit 140 may be determined (S23). While the priority order is determined, the information (e.g., the energy information) transmitted through the communication unit 110 may be interpreted. That is, it is determined whether a high-price period is recognized (S24).

If the high-price period is unrecognized, a user pattern to be driven may be selected according to a priority order in which the power consumption amount or the energy charge of the user pattern is reduced. For example, one user pattern in which the energy charge is lowest may be determined as the first priority order. Thus, the energy consumption component 100 may be driven according to the user pattern having the first priority order (S27).

On the other hand, when the high-price period is recognized in the operation s24, the energy consumption component 100 may enter a standby mode (a mode in which a main power is blocked, and a standby power for operating the display unit is supplied) (S25). Thereafter, it is determined whether the high-price period is ended. When the high-price period is ended, an operation S27 is performed.

When a second mode (the manual mode), but the first mode (the automatic mode) is selected in operation S22, the energy consumption component 100 may be driven according to the second mode. Here, as described above, before the second mode is performed, the user pattern information may be displayed in operation s28.

According to the above-described control method, the user may drive the energy consumption component so that the power consumption amount or the energy charge are saved according to a user own usage pattern.

Another embodiment will be proposed.

Although the pattern of the energy consumption component 100 is driven according to the priority order in a case where the high-price period is unrecognized in operation S24, the present disclosure is not limited thereto. For example, even though the high-price period is recognized, the operation S27 may also be performed. In this case, a priority order in which the power consumption amount or the energy charge is reduced may be driven according to the high-price information and the user pattern information.

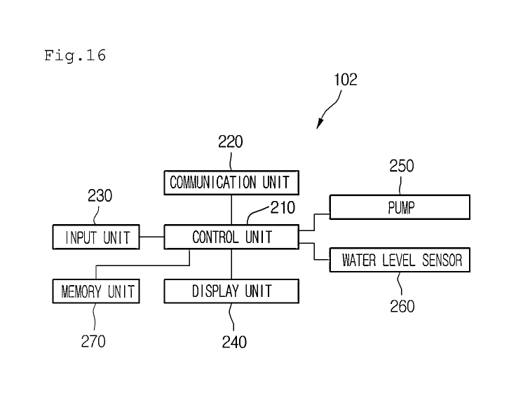

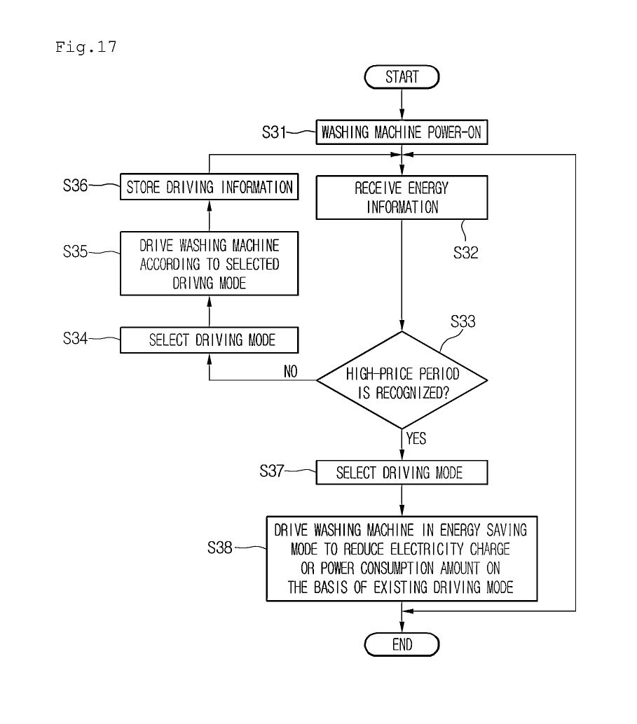

FIG. 16 is a perspective view of a washing machine which is an example of the energy consumption component constituting the home area network according to an embodiment. FIG. 17 is a flowchart for explaining a method of controlling the washing machine of FIG. 16.

Referring to FIG. 16, a washing machine 102 constituting the home area network may include a control unit 210, a communication unit 220, an input unit 230 for inputting a driving condition, a display unit 240 for displaying at least one of a driven state, information related to energy, and additional information, a drum motor 250 for rotating a drum in which laundry is received, a heater 260 for heating washing water or an inner space of the drum, and a memory unit 270 for storing at least driving information of the washing machine 102 and energy consumption information (or usage electricity charge information) when the washing machine 102 is driven.

The communication unit 220 may communicate with one component constituting the home area network or a utility network. Also, the communication unit 220 may communicate with the control unit 210. The control unit 210 may receive first to third information through the communication unit 220.

The control unit 210 may recognize the information related to energy to operate the drum motor 250 and the heater 260 according to the recognized information. That is, the control unit 210 may recognize high-price period information. When the control unit 210 recognizes the high-price period information, the control unit 210 controls operations of the heater and the motor to reduce the energy consumption amount and/or electricity charge.

The driving condition of the washing machine 102 may be inputted, and the mode for saving the energy may be selected through the input unit 230. For example, a standard mode (course), a blanket washing mode, a wool washing mode, and a steam washing mode may be selected through the input unit 230.

Referring to FIG. 17, the washing machine 102 is turned on to operate the washing machine 102 (S31). The washing machine 102 receives energy information (S32). Then, the control unit 210 recognizes a high-price period or a low-price period on the basis of the received energy information (S33).

When a driving mode is selected in a state where the control unit 210 does not recognize the high-price period (or recognizes the low-price period) (S34), the washing machine 102 is driven according to the selected driving mode (S35). That is, the drum motor 250 and the heater 260 may be driven by a normal output set in the selected mode. Also, the driving information of the washing machine 102 is stored in the memory unit 270 (S36).

On the other hand, when the driving mode is selected in a state where the control unit 210 recognizes the high-price period (S35), the washing machine 102 is driven in an energy saving mode to reduce the electricity charge or the power consumption amount (energy consumption amount) on the basis of the existing driving information stored in the memory unit 270.

In detail, the control unit 210 determines a mean power consumption amount (mean electricity charge) for each time by dividing the total power consumption amount (the total electricity charge) accumulated for a specific period such as a week or a month into a washing number. Also, the control unit 210 determines an estimated power consumption amount when the washing machine 102 is driven according to the selected mode. The estimated power consumption amount may be determined on the basis of a power consumption amount when the washing machine 102 is previously driven according to the same mode.

Also, the control unit 210 compares the estimated power consumption amount with the mean power consumption amount to control the driving of the washing machine so that an actual power consumption amount of the washing machine is equal to or less than the mean power consumption amount when the estimated power consumption amount is greater than the mean power consumption amount. For example, the control unit 210 may control the drum motor and the heater so that outputs of the drum motor and the heater in the energy saving mode is less than normal outputs of the drum motor and the heater in the selected mode.

On the other hand, the control unit 210 compares the estimated power consumption amount with the mean power consumption amount to drive the washing machine in the selected mode when the estimated power consumption amount is equal to the mean power consumption amount.

According to the current embodiment, when the control unit 210 recognizes the high-price period information, the estimated power consumption amount in the selected mode is compared with the mean power consumption amount of the washing machine to control the washing machine so that the actual power consumption amount does not exceed the mean power consumption amount to reduce the energy usage charge.

Also, since the driving of the component in which energy is consumed according to the energy information such as a variable energy change is varied, an energy source may be effectively managed.

Although the driving mode is selected in the state where the control unit recognizes the high-price period or the low-price period in the forgoing embodiment, the present disclosure is not limited thereto. For example, when the control unit recognizes the high-price period while the driving mode is selected and the washing machine is operated according to the selected mode, the current embodiment may be equally applied.

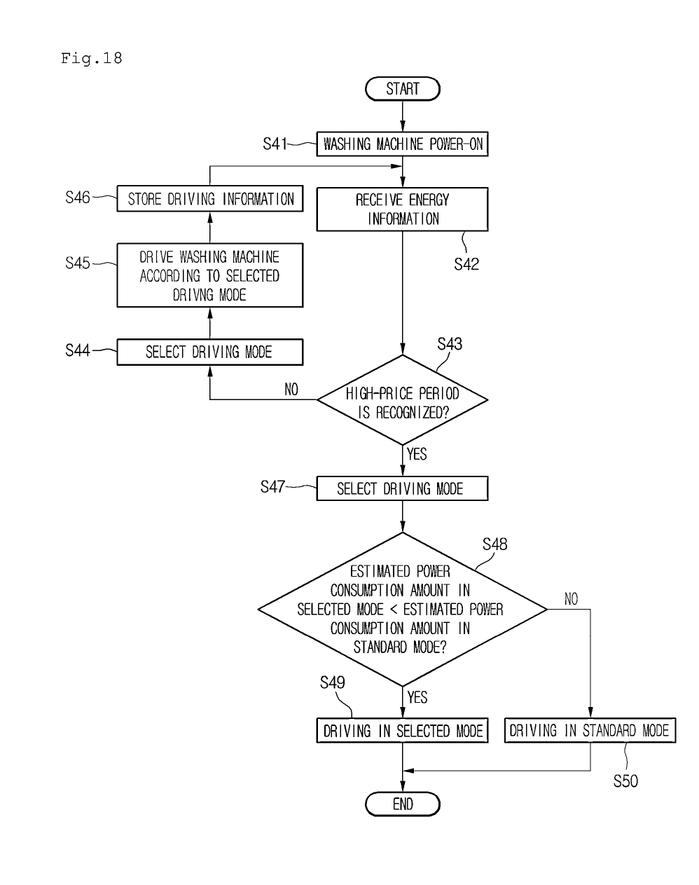

FIG. 18 is a flowchart for explaining a method of controlling a washing machine according to a second embodiment.

Referring to FIG. 18, a washing machine 102 is turned on to operate the washing machine 102 (S41). The washing machine 102 receives energy information (S42). Then, a control unit 210 recognizes a high-price period or a low-price period on the basis of the received energy information (S43).

When a driving mode is selected in a state where the control unit 210 does not recognize the high-price period (or recognizes the low-price period) (S44), the washing machine 102 is driven according to the selected driving mode (S45). That is, a drum motor 250 and a heater 260 may be driven by a normal output set in the selected mode. Also, the driving information of the washing machine 102 is stored in a memory unit 270 (S46).

On the other hand, when the driving mode is selected in the state where the control unit 210 recognizes the high-price period (S47), the control unit 210 determines whether an estimated power consumption amount in the selected mode is less than an estimated power consumption amount in a standard mode (S48). Here, the standard mode may be previously set when the washing machine is produced. On the other hand, a user may set or change the standard mode and a specific operation method in the standard mode. When the user sets the standard mode, the set mode may be stored in the memory unit 270. In the current embodiment, for example, the standard mode may be set as a mode for reducing electricity charge or energy consumption. Also, an estimated power consumption amount in the selected mode and an estimated power consumption amount in the standard mode may be determined on the basis of the information stored in the memory unit 270.

If when the estimated power consumption amount in the selected mode is less than the estimated power consumption amount in the standard mode, the washing machine is driven in the selected mode (S49). On the other hand, if the estimated power consumption amount in the selected mode is greater than the estimated power consumption amount in the standard mode, the selected mode is changed into the standard mode to drive the washing machine in the standard mode (S50).

According to the current embodiment, when the control unit 210 recognizes the high-price period information, the estimated power consumption amount in the selected mode is compared with the estimated power consumption amount in the standard to control the washing machine so that the actual power consumption amount of the washing machine does not exceed the estimated power consumption amount in the standard mode to reduce the energy usage charge.

Although the driving mode is selected in the state where the control unit recognizes the high-price period or the low-price period in the forgoing embodiment, the present disclosure is not limited thereto. For example, when the control unit recognizes the high-price period while the driving mode is selected and the washing machine is operated according to the selected mode, the current embodiment may be equally applied.

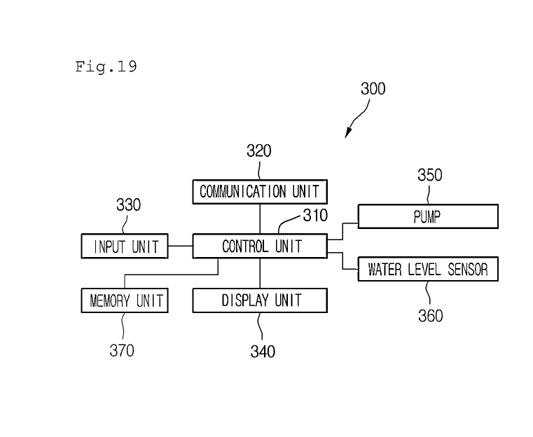

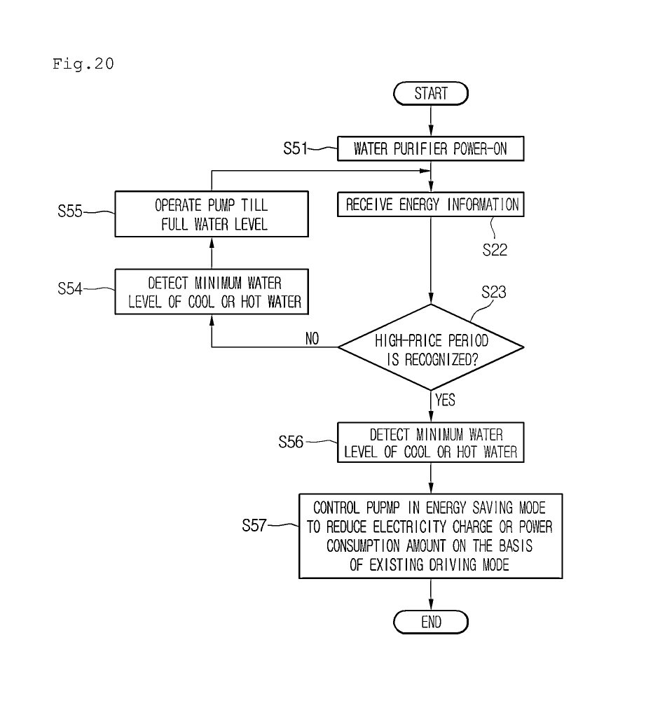

FIG. 19 is a block diagram of a water purifier which is an example of the energy consumption component constituting the home area network according to an embodiment. FIG. 20 is a flowchart for explaining a method of controlling the water purifier of FIG. 19.

Referring to FIG. 19, a water purifier 300 constituting the home area network may include a control unit 310, a communication unit 320, an input unit 330 for inputting a driving condition, a display unit 340 for displaying at least one of a driven state, energy information, and additional information, a pump 350 for supplying water, a water level sensor 360 for detecting a water level of a water storage bath, and a memory unit 370 in which cool water or hot water usage information of the at least water purifier 300 is stored.

The control unit 310 may recognize high-price period information. When the control unit 310 recognizes the high-price period information, the control unit 310 controls an operation of the pump 350 to reduce the energy consumption amount and/or energy charge.

Referring to FIG. 20, the water purifier 300 is turned on to operate the water purifier 300 (S51). The water purifier 300 receives energy information (S52). Then, the control unit 310 recognizes a high-price period or a low-price period on the basis of the received energy information (S53).

A minimum water level of a cool water bath and/or a hot water bath may be detected in a state where the control unit 310 does not recognize the high-price period (or recognizes the low-price period) (S54). Then, the control unit 310 controls an operation of the pump 350 so that the cool water bath and/or the hot water bath has(have) a maximum water level (S55).

On the other hand, in the state where the control unit 310 recognizes the high-price period, the minimum water level of the cool water bath and/or the hot water bath may be detected (S56). Thus, the control unit 310 controls the operation of the pump 350 in an energy saving mode so that an electricity charge or power consumption amount is reduced on the basis of the existing information (S57).

In detail, for example, cool water or hot water usage amount for a day or a mean cool water or hot water usage amount for a day during a specific period (e.g., a week) may be stored in the memory unit 370.

Also, when the minimum water level is detected in the state where the control unit 310 recognizes the high-price period, the control unit 310 controls the pump 350 so that water is supplied by cool water or hot water usage amount for a day or mean cool water or hot water usage amount for a day.

According to the current embodiment, a pump driving time in the high-price period is less than that in the low-price period. Thus, since the pump driving time in the high-price period is reduced, the energy charge may be reduced.

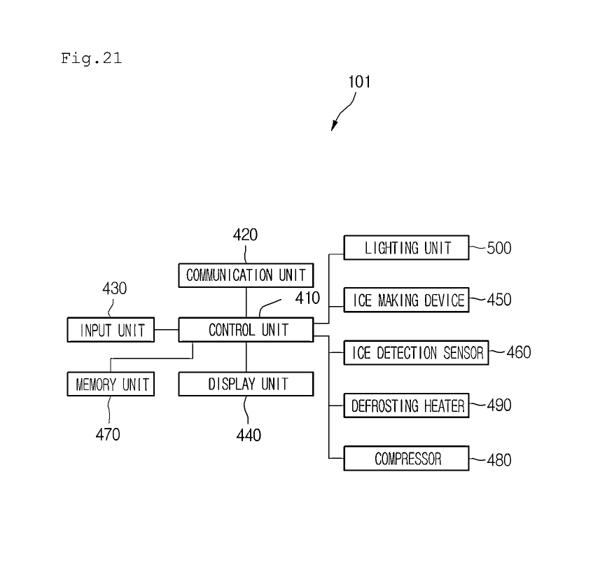

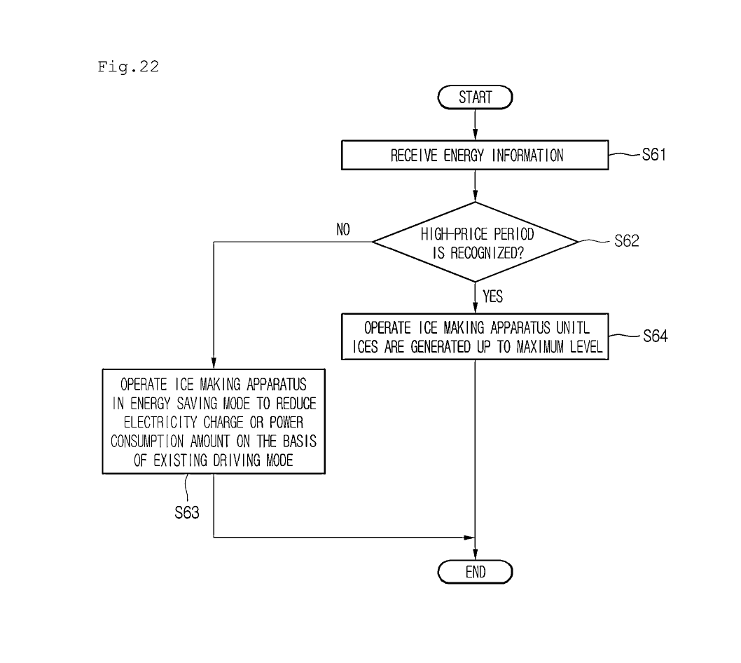

FIG. 21 is a block diagram of a refrigerator which is an example of the energy consumption component constituting the home area network according to an embodiment. FIG. 22 is a flowchart for explaining a method of controlling the refrigerator of FIG. 21.

Referring to FIG. 21, a refrigerator 101 constituting the home area network may include a control unit 410, a communication unit 420, an input unit 430 for inputting a driving condition, a display unit 440 for displaying at least one of a driven state, energy information, and additional information, an ice making device 450 for generating and storing ices, an ice detection sensor 460 for detecting an amount of ices, and a memory unit 470 in which dispensing information of at least ices is stored. The refrigerator 101 may include a lighting unit 500 for illuminating the inside of the refrigerator and/or the display unit 440, a compressor 480 for compressing a refrigerant, and a defrosting heater 490 for removing frost.

The control unit 410 may recognize energy information. Also, the control unit 410 controls operations of the ice making device 450, the compressor 480, the defrosting heater 490, and a lighting unit 500 according to the recognized information. That is, the control unit 410 may recognize high-price period information. When the control unit 410 recognizes the high-price period information, the control unit 410 controls an operation of the ice making device 450 to an energy consumption amount and/or energy charge. Also, the control unit 410 controls an operation of the ice making device 450 according to information detected by the ice detection sensor 460.

Referring to FIG. 22, the refrigerator 101 receives energy information while the refrigerator 101 is driven. Then, the control unit 410 recognizes a high-price period or a low-price period on the basis of the received energy information (S62).

In a state where the control unit 410 does not recognize the high-price period (or recognizes the low-price period), the control unit 410 controls an operation of the ice making device 450 so that a storage amount of ices is maximized (S63). When the storage amount of ices is maximized, the operation of the ice making device 450 is stopped.

On the other hand, in a state where the control unit 410 recognizes the high-price period, the control 410 controls an operation of the pump 450 so that an electricity charge or power consumption amount is reduced on the basis of the existing information (S34).

In detail, for example, an ice dispensing amount for a day or a mean ice dispensing amount for a day during a specific period (e.g., a week) may be stored in the memory unit 470. Also, in the state where the control unit 410 recognizes the high-price period, the control unit 410 controls the operation of the ice making device 410 so that ices are generated by the ice dispensing amount for a day or the mean ice dispensing amount for a day. In the current embodiment, the ices or water received in the home appliances (e.g., the refrigerator, water purifier, etc) may be called a resource.

Also, in the current embodiment, water may be received in the refrigerator. In this case, the descriptions with respect to the water purifier may be equally applied to the refrigerator. Also, in the current embodiment, water may be received in the refrigerator. In this case, the descriptions with respect to the water purifier may be equally applied to the refrigerator.

In a case of an air conditioner except the refrigerator and the water purifier, an operation of the air conditioner may be varied on the basis of an average of a desired temperature for a specific time and an average of wind intensity (an average of a target value set by a user). Also, in a case of a dehumidifier, an operation of the dehumidifier may be varied on the basis of an average of desired moisture for a specific time and an average of dehumidified amount (an average of a target value set by the user).

Also, although the washing machine is described an example of a product in which the standard mode is provided or set, the present disclosure is not limited thereto. For example, the current embodiments may be applied to various products such as a dryer, a dishwasher, a cooling appliance, and the like.

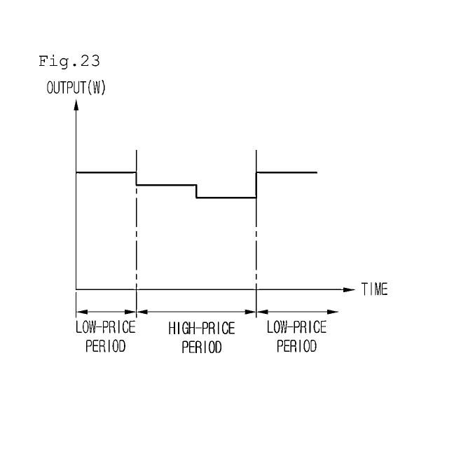

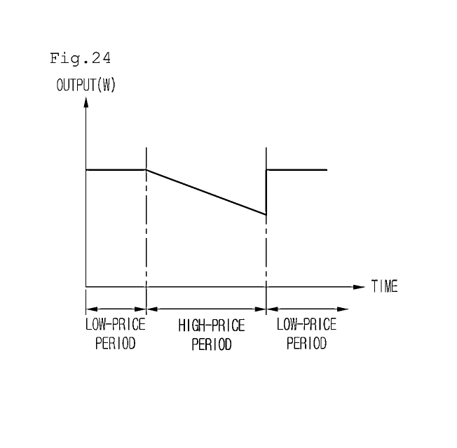

FIG. 23 is a graph illustrating an output variation of one component in high-price and low-price periods according to the first embodiment. FIG. 24 is a graph illustrating an output variation of one component in high-price and low-price periods according to the second embodiment. Hereinafter, a lighting unit of a refrigerator will be described as an example of the component.

Referring to FIGS. 21 and 23, the control unit 410 of the refrigerator may recognize the information related to the energy. For example, the control unit 400 may recognize the high-price period (e.g., an on-peak time) and the low-price period (e.g., an off-peak time). The control unit 410 controls the lighting unit 500 so that the lighting unit has different outputs in the high-price period and the low-price period.

In detail, when the control unit 410 recognizes the high-price period while the control unit 410 recognizes the low-price period, the control unit 410 controls the lighting unit 500 so that an output of the lighting unit 500 in at least one period of the high-price period is less than that of the light unit 500 in the low-price period. That is, the output of the lighting unit 500 for a predetermined time in the high-price period may be less than that of the lighting unit in the low-price period.

Here, the output of the lighting unit 500 in the high-price period may be varied. For example, as shown in FIG. 23, the output of the lighting unit 500 in the at least one period of the high-price period may be reduced in stages. On the other hand, as shown in FIG. 24, the output of the lighting unit 500 in the at least one period of the high-price period may be continuously reduced. Of cause, the output of the lighting unit in the whole period of the high-price period may be continuously reduced.

Particularly, when the control unit 410 recognizes a signal such as a Boolean signal in real-time, the control unit 410 may reduce the output of the lighting unit 410 in stages according to a time (or a driving time elapse) elapsed for recognizing the signal (may be divided into at least two parts). For example, the output of the lighting unit 500 may be reduced by about 200 W before about 10 minutes (a reference value) does not elapse after the signal is recognized. Also, after about 10 minutes elapse after the signal is recognized, the output of the lighting unit 500 may be additionally reduced by about 200 W (about 400 W than that in the low-price period). Although the output is reduced in two stages in the high-price period in the current embodiment, the present disclosure is not limited thereto. For example, the output of the lighting unit 500 may be reduced in three stages or more.

Alternatively, the reduction of the output of the lighting unit in the high-price period may be varied according to the power consumption amount of the lighting unit. For example, the output of the lighting unit may be maintained in the state in which the output is reduced by about 200 W at a time point at which the high-price period is recognized. When the total power consumption amount (or the total usage electricity charge) of the lighting unit exceeds a reference value, the output of the lighting unit may be maintained in the state in which the output is additionally reduced by about 200 W. Also, when the low-price period is recognized while the control unit 410 recognizes the high-price period, the output of the lighting unit 500 may return to its original output.

When the control unit 410 recognizes a plurality of leveled charge information (a high level, a middle level, and a low level) in a schedule information form or a real-time information form, the output of the lighting unit 500 may be varied according to the charge levels. For example, if the charge is the low level, the original output of the lighting unit 500 may be maintained. If the charge is the middle level, the output of the lighting unit may be reduced by about 50 W. If the charge is the high level, the output of the lighting unit may be reduced by about 100 W. Here, when the charge is set to the high-price period in the middle and high levels, it may be understood that the output of the lighting unit 500 is varied during the high-price period. Also, when the charge is charged into an order of the middle, high, and middle levels in the high-price period (the charge is the middle or high level), the output may be increased in the high-price period than before. Here, the output in the high-price period may be set so that the output is not increased than that in the low-price period. Also, when the charge is maintained to the high level state in the high-price period, a degree of the reduction of the output may be varied according to the total time in the high-price period.

For example, when the high-price period is about 30 minutes, the output of the lighting unit may be reduced by about 200 W till about 15 minutes first. Then, after about 15 minutes elapse, the output may be additionally reduced by about 200 W (about 400 W than that in the low-price period). On the other hand, when the high-price period is about one hour, the output of the lighting unit may be reduced by about 300 W till about 30 minutes first. Then, after about 30 minutes elapse, the output may be additionally reduced by about 200 W.

The control unit 410 levels RTP charge information into a plurality of period when the RPT charge information is recognized as the schedule information form. Thus, the output of the lighting unit may be varied according to the levels.

According to the current embodiment, when the control unit recognizes the high-price period information, the output of the component in which energy is consumed may be reduced. Thus, the energy consumption amount and energy charge may be reduced. Here, the reduction of the energy consumption amount and energy charge of the component energy is consumed may be understood that the total energy consumption amount and energy charge of an electric product including the component are reduced.

Also, since the driving of the component in which energy is consumed according to the energy information such as a variable energy change is varied, an energy source may be effectively managed.

According to the above-described embodiments, while the control unit recognizes the high-price period, energy supplied from the utility network is not used, energy stored in the energy storage component constituting the home area network is used.

Also, the reduction of the output of the lighting unit may be exemplified. Thus, the reduction of the output may be varied according to a position of the lighting unit (the inside of the refrigerator or in the display unit).

Also, although the refrigerator is descried as an example, the current embodiment may be applied to all electric products including the component (a heater, a lighting unit, a pump, a valve, a motor, etc) in which energy is consumed.

Hereinafter, various examples of the operating method of the component will be described.

First, if a start command is inputted by the input unit, optimal driving time information or information (driving method) except the time of the component is determined (determination of the optimal driving condition). The optimal driving time information or the information except time is determined so that an electricity usage charge or power consumption amount is decreased. The optimal driving time information may be determined so that the component is immediately driven at a current time, that the component is driven at a selected time or that the driving of the component is delayed. In a case where the optimal driving time is later than the time (current time) recognized by a user, information for informing the user of this fact may be displayed in the display unit. A driving method or time may be inputted through the input unit 120 before the start command is inputted through the input unit 120, and the inputted driving mode or time may be changed or maintained by the determination of the optimal driving time information or time except information. That is, in a case where a specific operation condition is inputted through the input unit, the driving condition of the component is determined on the basis of at least information related to energy charge. Then, the component is operated according to the determined optimal driving condition. Information changed from the inputted driving operation condition in the optimal driving condition or information not inputted may be displayed in the display unit.

As another example, if at least a portion of the high-price period is included in a driving time period of the component, the driving time period may be changed. Specifically, the driving time period may be defined by a driving start time and a driving end time. The change of the driving time period refers to a change of at least one of the driving start time and the driving end time. If the driving time period is changed, the component may not be operated in at least a portion of the high-price period. As an example, if the high-price information is recognized while the component is operated, the operation of the component may be immediately stopped. Alternatively, if the high-price information is inputted while the component is operated, the operation of the component may be stopped after the component is operated for a certain period of time. If the high-price period is ended, the component in a non-operation state may be re-operated. The driving time period may be changed entirely or partially. The end time of the changed driving time period may be a time when the high-price information is recognized or the previous time (the low-price period prior to the high-price period).

Alternatively, the end time of the changed driving time period may be positioned at a low-price period that comes after the high-price period is ended. Alternatively, the start time of the changed driving time period may be positioned at a low-price period that comes after the high-price period is ended.

As another example, if an driving mode is selected through the input unit, energy information related to the mode selected in the display unit may be displayed. For example, in a case where a specific driving mode is selected, electricity charge per unit power for each time zone, total electricity usage charge in the operation of a corresponding mode, total power consumption amount and the like may be displayed.

Alternatively, the component may be operated in one of a plurality of power saving modes. That is, the component may be operated in any one of the plurality of power saving modes so as to reduce energy consumption or energy usage charge according to the kind of at least the energy information. The plurality of power saving modes may include a manual mode in which information for driving the component is manually selected, and an automatic mode in which the information for driving the component is automatically selected. The component may be operated in a time reduction mode in addition to the general mode and the power saving mode. The time reduction mode may be manually selected by the user. In the time reduction mode, the driving time of the component is shorter than that of the component in the general mode. In this instance, the energy usage charge (or energy consumption) in the time reduction mode may be equal to or greater than the energy usage charge (or energy consumption) in the general mode. The energy usage charge (or energy consumption amount) in the time reduction mode may be changed by varying the operation method of the component. The driving time of the component in the power saving mode is equal to or longer than that of the component in the general mode. In this instance, performances (e.g., washing performances, cooking performances or the like) of the component in the general mode, the time reduction mode and the power saving mode may be identical or similar to one another.

As another example, the plurality of power saving modes may include a mode leveled corresponding to the degree of reduction of electricity charge or power consumption amount. For example, the power consumption amount or electricity usage charge when the component is operated in a first power saving mode may be smaller than that when the component is operated in a second power saving mode. Alternatively, the plurality of power saving mode may include at least two modes that share a common control unit or method for the purpose of the power-saving driving of the component. The plurality of power saving modes may be mutually changed manually or automatically. Alternatively, the plurality of power saving modes may control the component using different methods from one another. That is, the control methods of the component are different from one another in the plurality of power saving modes.

As another example, the component may recognize estimated power information related to power to be consumed in the component or another component. In this instance, the estimated power information may be information on at least one of current, voltage, power, electric energy, electricity charge.

The estimated power information corresponding to the driving mode of the component or another component may be made as a table and then stored in the memory unit of the component. For example, power consumption information corresponding to the selected course or mode may be stored in the memory unit, and an estimated electricity usage charge may be determined by the multiplication of the power consumption and charge. Alternatively, the respective power consumption information of the plurality of energy consumption units constituting the component may be stored in the memory unit. Also, an estimated electricity usage charge may be determined by the multiplication of the sum of the power consumption amount of the energy consumption units driven when the component is driven and the charge.

Additional information corresponding to the driving mode of the component or another component, e.g., performance or efficiency information may be stored in the memory unit of the component. Therefore, if the driving mode of the component or another component is recognized, the component may recognize estimated power information corresponding to the recognized driving mode. The recognized estimated power information may be displayed in the display unit of the component or in a display unit of another component. The actual power consumption amount information or actual electricity usage charge information in the operation of the component or another component may be recognized. In a case where it is required to correct the estimated power information, the estimated power information may be corrected based on the actual power consumption amount information or actual electricity usage charge information. The actually used electric energy or actually used charge when the component is operated or after the operation of the component is ended may be displayed in the display unit of the component. Alternatively, during the operation of the component, the estimated power information may be displayed, or the estimated power information and the actually used information may be simultaneously displayed. Alternatively, the optimal time or charge may be determined within a specific time range based on the estimated power information stored in the memory unit. The optimal time may be an operation start time of the component. The optimal charge may be an energy usage charge generated when the component is operated at a specific time. In a case where the energy charge information is real-time information, the optimal charge may be determined based on the previous energy charge information stored in the memory unit. Then, in a case where the energy charge is changed, the optimal charge may be corrected by reflecting the changed charge.

A plurality of conditions for configuring the driving mode may be selected by the user, and estimated power information or additional information corresponding to an driving mode configured under a selected condition may be displayed in the display unit of the component. An arbitrary driving mode (user preference mode) may be stored in the memory unit of the component, and the user preference mode may be selected using the input unit. For example, the user may arbitrarily set the operation method of the component through the input unit, and the estimated power information and additional information in the operation of the component may be determined using the set operation method. The user may determine whether or not the user determines the set operation method as the user preference mode by identifying the estimated power information and the additional information.

As another example, a plurality of conditions for operating a plurality of components may be selected by the user, and estimated power information or additional information corresponding to an operation condition configured under a selected condition may be displayed in the display unit of the component. An arbitrary driving mode (user preference mode) may be stored in the memory unit of the component, and the user preference mode may be selected using the input unit. For example, the user may arbitrarily set the operation method of a refrigerator, washing machine, water cleaner, cooking appliance, air conditioner or the like, and the estimated power information and additional information in the operation of the component may be determined using the set operation method. The user may determine whether or not the user determines the set operation method as the user preference mode by identifying the estimated power information and the additional information.

As another example, the component may be driven based on energy information recognized by the component or information on a priority order in additional information. The priority order may be set or changed manually or automatically. The presence of consideration of the next priority order may be determined according to the information state of the best order.

For example, in a case where energy charge information as the energy information is a priority order and environment information as the additional information is a posterity order, the component may be operated based on the energy charge information. Alternatively, in a case where the energy information is a priority order and the additional information is a posteriority order, the energy information includes information related to the reduction of energy consumption or energy charge. Then, the component may be operated based on only the energy information. Alternatively, in a case where the additional information is a priority order and the energy information is a posteriority order, the power or operation time of the component is necessarily increased as a determined result of the additional information. Then, the component may be driven in consideration of the energy information.

Alternatively, the component may include a memory unit in which the operation method of the component is determined by reflecting information on plural kinds of components. If the component recognizes the information on the plural kinds of components, one of operation methods stored in the memory unit is selected.

As another example, the component may further include a memory unit in which the operation method obtained by reflecting the energy information and additional information is stored. Therefore, if the information on the plural kinds of components is recognized, one of the operation methods stored in the memory unit may be selected, and the component may be operated using the selected operation method.

As another example, if high-price information is recognized in the operation of the component, the operation information of the component is stored in the memory unit, and the component may be turned off or stopped. Then, if low-price information is recognized, the component may be driven again on the basis of the operation information stored in the memory unit.

As another example, in a case where the energy consumption or energy usage charge of the component according to the operation condition of the component, inputted by the user, exceeds a limitation reference, the component may be forcibly controlled so that the energy consumption or energy usage charge is less than the limitation reference, or a driving method for allowing the energy consumption or energy usage charge to be less than the limitation reference may be displayed in the display unit of the component. In a case where the component is forcibly controlled, information for informing the user of the fact may be displayed in the display unit of the component.

As another example, if the high-price information is recognized while the component is operated using the selected driving method, the driving method may be changed or maintained according to the driving method of the component. For example, if the estimated power consumption (or estimated energy usage charge) when the component is operated using the selected driving method is greater than that when the component is operated using a standard driving method, the selected driving method may be changed into the standard driving method. If the estimated power consumption (or estimated energy usage charge) when the component is operated using the selected driving method is equal to or smaller than that when the component is operated using the standard driving method, the selected driving method may be maintained. The standard driving method may be set when the component is manufactured, or may be manually set or changed by the user. Alternatively, the standard driving method may include a plurality of methods, and a specific method may be selected according to the kind of low-price information.

As another example, an energy reduction degree (degree of reducing a power consumption amount or electricity charge) may be differently selected according to the kind or state of energy information or additional information. For example, the energy reduction degree may be differently selected based on the length of a time period greater than the level or value of the energy information or additional information. The reduction degree of electricity charge or power consumption when the value of the energy information or additional information is greater than the reference information value is greater than that of electricity charge or power consumption when the value of the energy information or additional information is smaller than the reference information value. The reference information value may be set as a plurality of reference information values. Also, at least one of the plurality of reference information values may be a value for determining an on-peak time period. Specifically, the length of the on-peak time period may be divided into top, middle and bottom, for example. The reduction degree when the length of the on-peak time period is top is greater than that when the length of the on-peak time period is middle or bottom. Alternatively, in a case where the electricity charge is divided into a plurality of levels, the reduction degree when the electricity charge is expensive is greater than that when the electricity charge is cheap.

As another example, the reduction method for reducing energy may be differently selected according to the kind or state of the energy information or additional information. For example, in a case where the component is a refrigerator, a compressor may be turned off when the length of the on-peak time period is within a first reference value (first method), and the cooling force of the compressor may be changed when the length of the on-peak time period is between the first reference value and a second reference value greater than the first reference value (second method). In a case where the length of the on-peak time period is more than a third reference value greater than the second reference value, the target temperature of a storage chamber may be increased (third method). Alternatively, the reduction method may be changed in the period in which the high-price information is recognized. If a predetermined time elapses while the first method is performed in the recognition of the high-price information, any one of the second and third methods may be performed, or the second and third methods may be sequentially performed.

As another example, in a case where the component includes a plurality of energy consumption components, the energy consumption components to be controlled may be differently selected according to the kind or state of the energy information or additional information. For example, the energy consumption components to be controlled may be differently selected according to the energy charge value or energy charge level. The reference information may include first reference information and second reference information greater than the first reference information. Alternatively, the reference information value may include a single value. For example, if the value of the energy information or additional information is greater than the second reference information value, the power of a first energy consumption component (function performing component that consumes energy) may be controlled (operation limitation). If the value of the energy information or additional information is between the first and second reference information values, the power of a second energy consumption component (function performing component that consumes energy) may be controlled (operation limitation). If the value of the energy information or additional value is smaller than the first reference information value, electricity may be stored in an energy storage component (the operation of a function performing component that stores energy may be started). That is, any one of a plurality of control objects or methods may be selected according to the kind or state of the energy information or additional information.

As another example, if the high-price information is recognized in the operation of the component, among a plurality of energy consumption components that constitute the component, the function performance of one or more energy consumption components may be limited, and the function of the other one or more energy consumption components may be performed. The power consumption of the energy consumption components of which function is limited is greater than that of the energy consumption components of which function is performed. For example, in a case where the high-price information is recognized while a component with relatively high power is operated, energy consumption components with high power may be turned off, and energy consumption components with low power may be turned on.

As still example, if the high-price information is recognized in the operation of the component, the operation of energy consumption components that satisfy a limitation condition may be limited among a plurality of energy consumption components that constitute the component. In this instance, the limitation condition may be power consumption, energy used charge or limitation order. That is, among the plurality of energy consumption components, the operation of energy consumption components of which power consumption or energy use charge exceeds a reference value may be limited. Alternatively, the limitation condition may be power consumption that is relatively large among the plurality of energy consumption components.

As another example, in a case where the driving mode of the component 100 includes a plurality of processes, at least one of the plurality of processes may be limited in the period in which the high-charge information is recognized. The limitation means that the process is stopped or the power consumption in the performance of the process is decreased. For example, in a case where the component is a washing machine, the driving mode may be a standard course, quilt course, wool course or the like. The plurality of processes may include at least one of soaking, washing, rinsing, dehydrating, and drying processes. The limited process may be automatically set, or may be manually set or changed.

As another example, if the high-price information is recognized in the operation of the component, two or more of a plurality of factors related to the operation of one or more energy components (function performing components) that constitute the component may be changed. The factor may include operation speed, operation time, power, operation rate and the like. If the value related to any one of two or more factors is decreased, the value of another factor may be increased. As an example, when an energy consumption component, is a motor, the rotation speed of the motor may decrease, and a rotation time may increase. When the energy consumption component is a heater, the output of the heater may decrease, and an operation time may increase. That is, when high-price information is recognized, two or more factors associated with the operations of one or more energy consumption components may vary. Alternatively, when the energy consumption component is a motor, the operation pattern of the motor may vary. Specifically, when the energy consumption component is a motor that rotates a drum included in a washing machine or a washer, the motor may rotate in one direction or another direction. In the case of a washing machine or a washer, the motor is controlled for laundry to be lifted and then dropped. A drum driving motion may be changed according to the rotation speed of the motor and a rotation angle in a specific direction. The drum driving motion may be divided into a general driving motion and one or more special motions (which have a rotation speed faster than the general motion or a large rotation angle in one-time rotation). Furthermore, the power consumption amount of the motor that is driven in the special motion is greater than the power consumption amount of the motor that is driven in the general motion. In this example, when high-price information is reduced while the motor is being driven in the special motion, the washing machine or the washer may perform the general motion. When the high-price information is recognized while the general motion is being performed, the washing machine or the washer performs a specific motion to be originally performed at a time when low-price information is recognized.

As another example, only when the time for recognition of high-price information (e.g., on-peak time) exceeds a reference time, the control may be performed for reducing the energy which the component has used. Alternatively, high-price information is recognized, and then the control is immediately performed for reducing energy, and when the time for performing the control has passed a predetermined time, whether the high-price information may be recognized for maintenance or change of the current state may be again determined. This is intended to prevent the method of operating the component from being often changed.

As another example, the component 100 may be supplied with energy form a plurality of energy generation units. Specifically, the plurality of energy generation units may be a utility network different from each other. In this case, the ratio of energy transmitted from a plurality of energy generation units according to energy information may be changed. That is, in a case where the energy charge of a first energy generation unit is lower than that of a second energy generation unit, more energy in the first energy generation unit may be supplied to the component. In this case, the amount of energy supplied form each energy generation unit or the energy ratio may be displayed in the display unit of the component. Alternatively, one of a plurality of energy generation units may constitute a utility network, and the other may constitute a home area network. Even in this case, the energy ratio transmitted from a plurality of energy generation units in accordance with energy information may be varied. Alternatively, the component may receive energy from one of the plurality of energy generation units. For example, the component may receive energy from at least one energy generation unit selected from the plurality of energy generation units by comparing the estimated power consumption amount with the energy supply amount of the plurality of energy generation units.

In another example, the component 100 may have a plurality of compartments, and the plurality of compartments may be cooled or heated. Also, according to the type or state of the energy information that is recognized, the cooled or heated states of the plurality of compartments may be varied. For example, when high charge information is recognized, one or more compartments of the plurality of compartments may not be cooled or heated. Alternatively, levels of priority of the plurality of compartments may be determined, and the compartments may be cooled or heated in order of highest to least priority. Here, the highest priority for the plurality of compartments may be designated by a user or automatically. In another example, when high charge information is recognized, cold air or heat from one compartment may be routed to another compartment, from among the plurality of compartments. For example, when high charge information is recognized, heat from a cooking compartment may be supplied to a warming compartment to keep food warm.

According to the proposed embodiments, the energy source may be effectively managed.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a component for a network system, the method comprising:
recognizing energy information or additional information except the energy information;
determining a driving method of the component on the basis of former driving information of the component according to the recognized information; and
driving the component through the determined driving method.

2. The method according to claim 1, wherein, when the recognized information is high-price period information, the driving method of the component is determined on the basis of the former driving information of the component.

3. The method according to claim 2, wherein the driving method of the component is determined so that an energy usage amount or energy usage charge of the component is equal to or less than former energy usage amount or energy usage charge of the component.

4. The method according to claim 1, wherein the former driving information of the component is information related to energy usage information or energy usage charge of the component.

5. The method according to claim 4, wherein the former driving information of the component is information related to a mean energy usage amount or mean energy usage charge of the component when the component is driven one time.

6. The method according to claim 1, wherein the former driving information of the component is an average of a target value set for a specific time.

7. The method according to claim 1, wherein the former driving information of the component is information related to a resource received in the component when the component is driven for a specific time.

8. The method according to claim 7, wherein the information related to the resource is information related to a mean discharge amount of the resource for the specific time.

9. The method according to claim 7, wherein the resource comprises water or ices.

10. The method according to claim 1, wherein the former driving information of the component comprises driving modes or driving times of the component.

11. The method according to claim 10, wherein, when a priority order of the plurality of driving modes is defined, and the recognized information is high-price information, the component is driven according to the driving mode having a first priority order.

12. The method according to claim 1, further comprising selecting a driving mode of the component,
wherein, when the recognized information is low-price period information, the driving method of the component is determined on the basis of the selected driving mode.

13. The method according to claim 1, wherein the determining of the driving method is performed while the component is driven, and the current driving method of the component is changeable into a different method.

14. The method according to claim 13, wherein, when the recognized information is high-price period information, an output of the component when the component is driven through the changed driving method is reduced than that of the component when the component is driven the driving method before being changed.

15. The method according to claim 14, wherein the output of the component is reduced in stages in a portion or the whole of a high-price period.

16. The method according to claim 14, wherein the output of the component is continuously reduced in a portion or the whole of a high-price period.
